(19) United States
(12) Patent Application Publication
(10) Pub. No.: US 2011/0050982 A1
(43) Pub. Date: Mar. 3, 2011

(54) LENS BARREL AND IMAGING DEVICE

(75) Inventors: Norikazu KATSUYAMA, Osaka (JP); Fumio MURAMATSU, Kyoto (JP); Yusuke ADACHI, Osaka (JP)

(73) Assignee: Panasonic Corporation, Osaka (JP)

(21) Appl. No.: 12/869,720

(22) Filed: Aug. 26, 2010

(30) Foreign Application Priority Data
Aug. 28, 2009 (JP) 2009-197819
Aug. 28, 2009 (JP) 2009-197820

(51) Int. Cl. H04N 5/232; G02B 15/14

(52) U.S. Cl. 348/345; 359/700; 348/E05.045

(57) ABSTRACT

A lens barrel includes a focusing lens, a driver, and a controller. The focusing lens changes a state of focus by moving in the direction of an optical axis. The focusing lens is subject to a load which is dependent upon the position of the focusing lens along the optical axis. The driver is coupled to the focusing lens and produces a driving force to move the focusing lens along the optical axis at a predetermined speed. The controller is coupled to the driver to adjust the driving speed of the driver relative to the position of the focusing lens.

### CROSS-REFERENCE TO RELATED APPLICATIONS

This application claims priority under 35 U.S.C. §119 to Japanese Patent Application No. 2009-197819 filed on Aug. 28, 2009, and Japanese Patent Application No. 2009-197820 filed on Aug. 28, 2009. The entire disclosures of Japanese Patent Applications No. 2009-197819 and No. 2009-197820 are hereby incorporated herein by reference.

### BACKGROUND

1. Technical Field

The technology disclosed herein relates to a lens barrel and an imaging device having a focusing lens and a driver for driving the focusing lens.

2. Background Information

The utility of a camera suffers when the lens takes a long time to focus. In view of this, the camera disclosed in Japanese Laid-Open Patent Application 2006-189506 to Ishige et al. was developed to increase the lens focusing time. According to the Ishige et al. patent application, the orientation of the camera is detected by a sensor, and if the camera is in a horizontal state, the lens is capable of being instantly moved along the optical axis for a faster focusing time. But if the camera is not in a horizontal state, movement of the lens along the optical axis is slower, and thus produces a much slower focusing time.

But regardless of whether the camera is in a horizontal state, the lens is still subject to a load that interferes with the lens as it moves along the optical axis. So even if the camera is positioned horizontally, the focusing time is still much slower than desired.

In view of the above, it will be apparent to those skilled in the art from this disclosure that there exists a need for an improved lens barrel and imaging device. This invention addresses this need in the art as well as other needs, which will become apparent to those skilled in the art from this disclosure.

### SUMMARY

The lens barrel disclosed herein comprises a focusing lens, a driver and a controller. The focusing lens changes a state of focus by moving in the direction of an optical axis. The focusing lens is subject to a load which is dependent upon the position of the focusing lens along the optical axis. The driver is coupled to the focusing lens and produces a driving force to move the focusing lens along the optical axis at a predetermined speed. The controller is coupled to the driver to adjust the driving speed of the driver relative to the position of the focusing lens.

### BRIEF DESCRIPTION OF DRAWINGS

Referring now to the attached drawings, which form a part of this original disclosure:

FIG. 1 is a simplified diagram of the configuration of a digital camera;

FIG. 2 is a block diagram of the configuration of a camera body;

FIG. 3 is an oblique view of a digital camera;

FIG. 4A is a top view of a camera body, and

FIG. 4B is a rear view of a camera body;

FIG. 5 is an oblique view of an interchangeable lens unit;

FIG. 6 is a cross section of an interchangeable lens unit;

FIG. 7 is a diagram of the configuration of an optical system;

FIG. 8 is an exploded oblique view of an aperture unit and its surrounding parts;

FIG. 9 is an exploded oblique view of a cam barrel and its surrounding parts;

FIG. 10 is another exploded oblique view of a cam barrel and its surrounding parts;

FIG. 11 is an exploded oblique view of a biasing member and its surrounding parts;

FIG. 12 is a diagram illustrating contrast autofocus operation;

FIG. 13 is a graph of the load torque produced by a biasing member and the maximum speed of a focus motor;

FIG. 14 is a flowchart of the processing pertaining to a variable set speed method;

FIG. 15 is an example of a speed switching table;

FIG. 16 is a graph of the relation of the set speed of the focus motor, the maximum speed of the focus motor, the load torque, the pressure angle of the cam groove, and the shape of the cam groove with respect to the position of a focus movable unit in a second embodiment;

FIG. 17 is a graph of the relation of the set speed of the focus motor, the maximum speed of the focus motor, the load torque, the pressure angle of the cam groove, and the shape of the cam groove with respect to the position of a focus movable unit in a third embodiment; and

FIG. 18 is a graph of the relation of the set speed of the focus motor, the maximum speed of the focus motor, the load torque, the pressure angle of the cam groove, and the shape of the cam groove with respect to the position of a focus movable unit in a fourth embodiment.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

Overview of Digital Camera

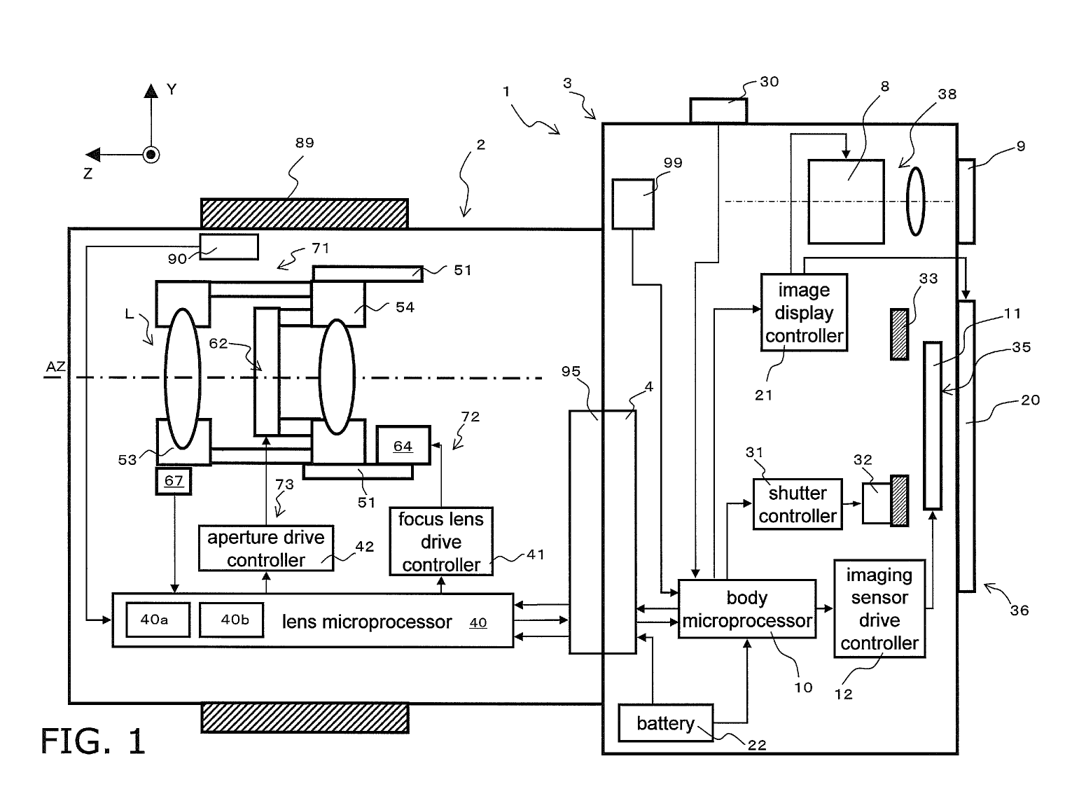

A digital camera 1 will be described through reference to FIGS. 1 to 11. FIG. 1 is a simplified diagram of the configuration of the digital camera 1. As shown in FIG. 1, the digital camera 1 (one example of an imaging device) is a digital camera with an interchangeable lens, and mainly includes a camera body 3 and an interchangeable lens unit 2 (one example of a lens barrel) that is removably mounted to the camera body 3. The interchangeable lens unit 2 is mounted via a lens mount 95 to a body mount 4 provided to the front face of the camera body 3.

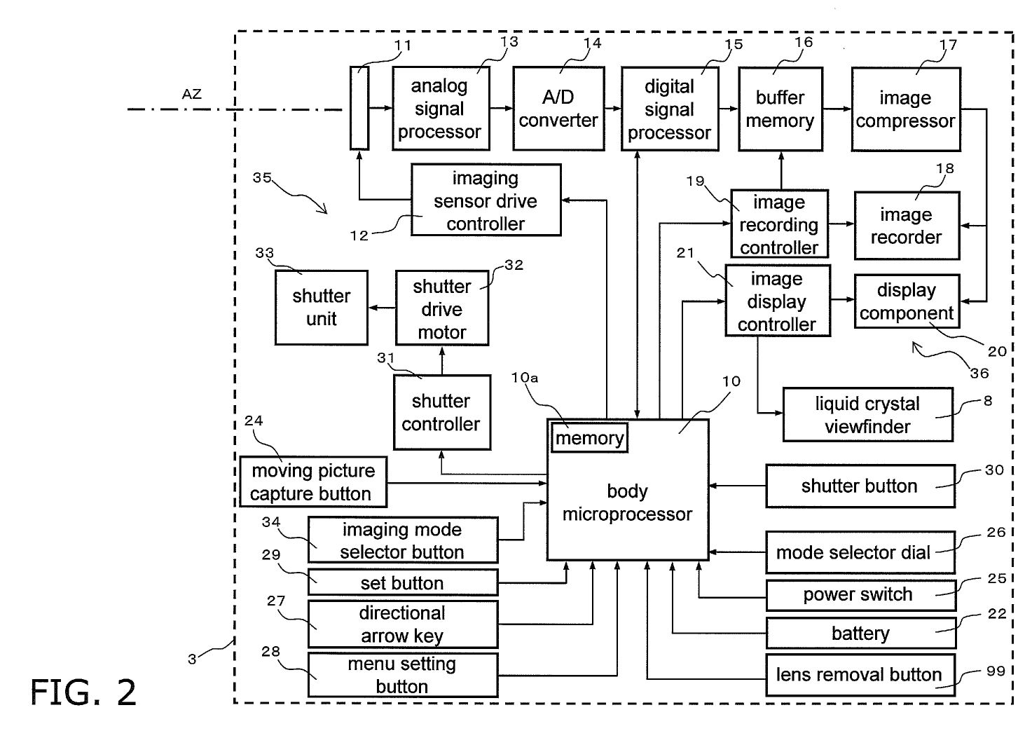

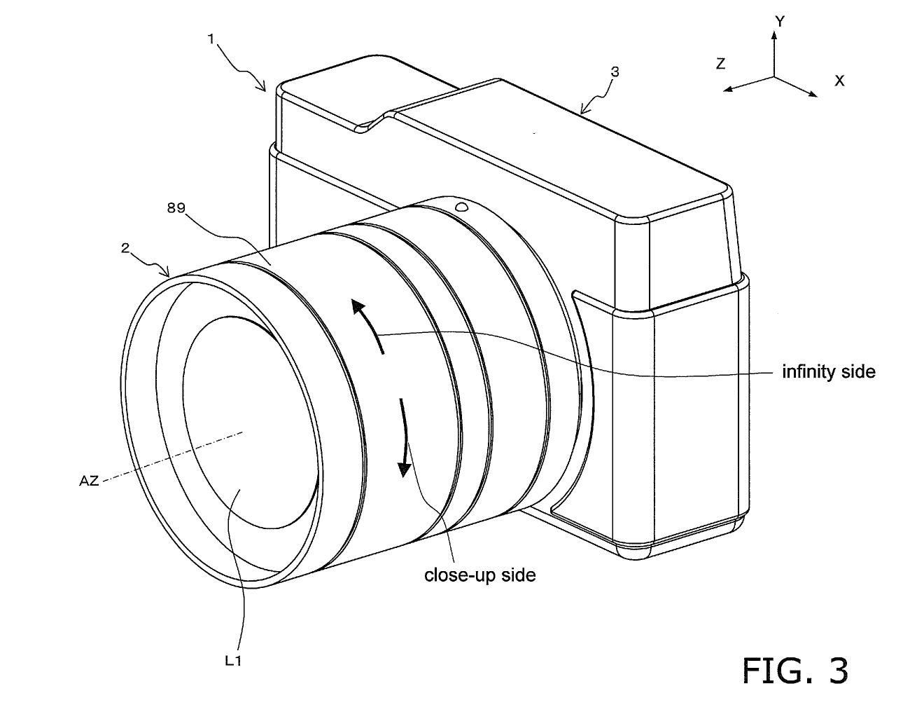

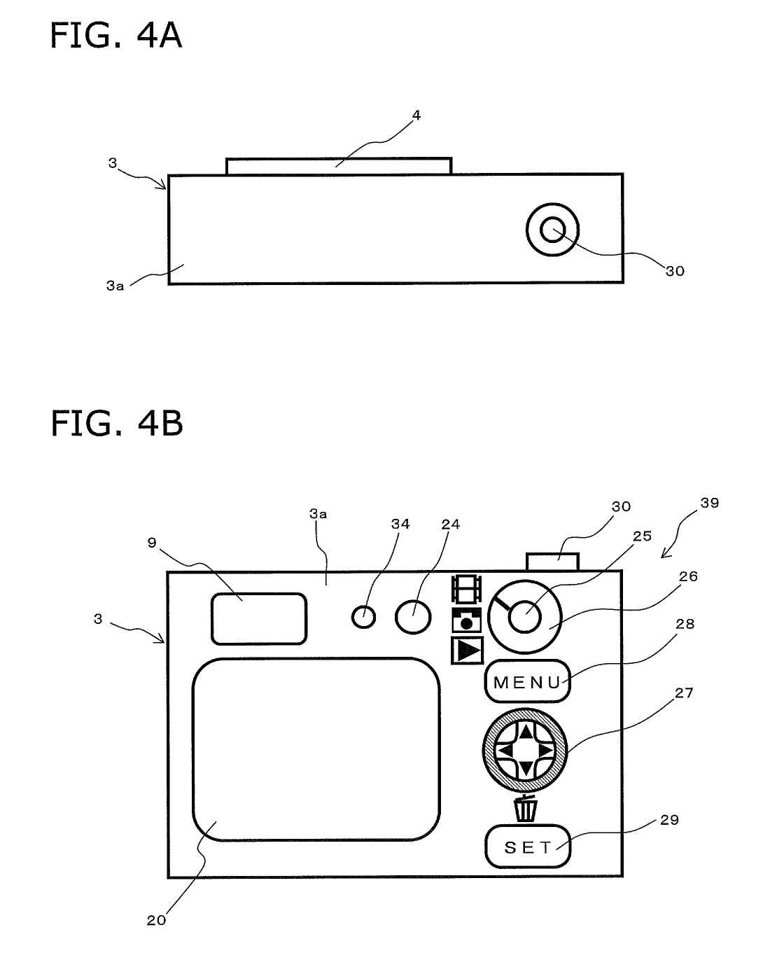

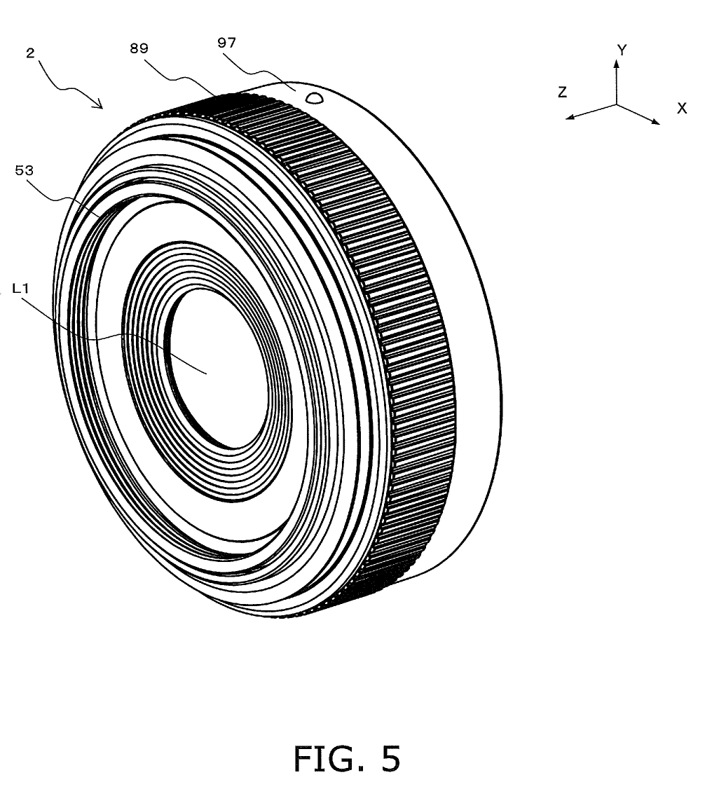

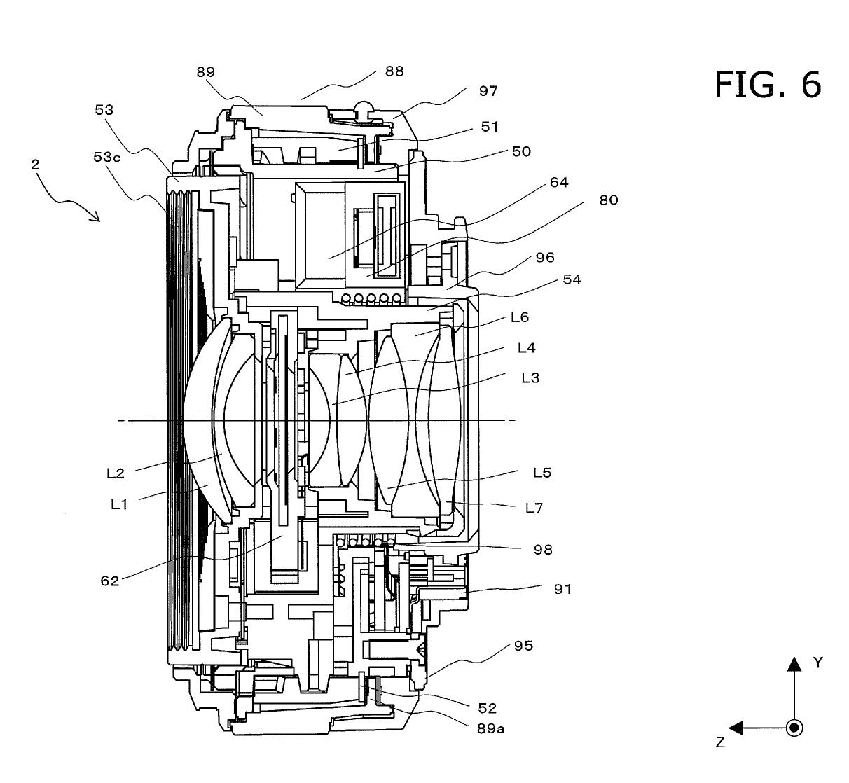

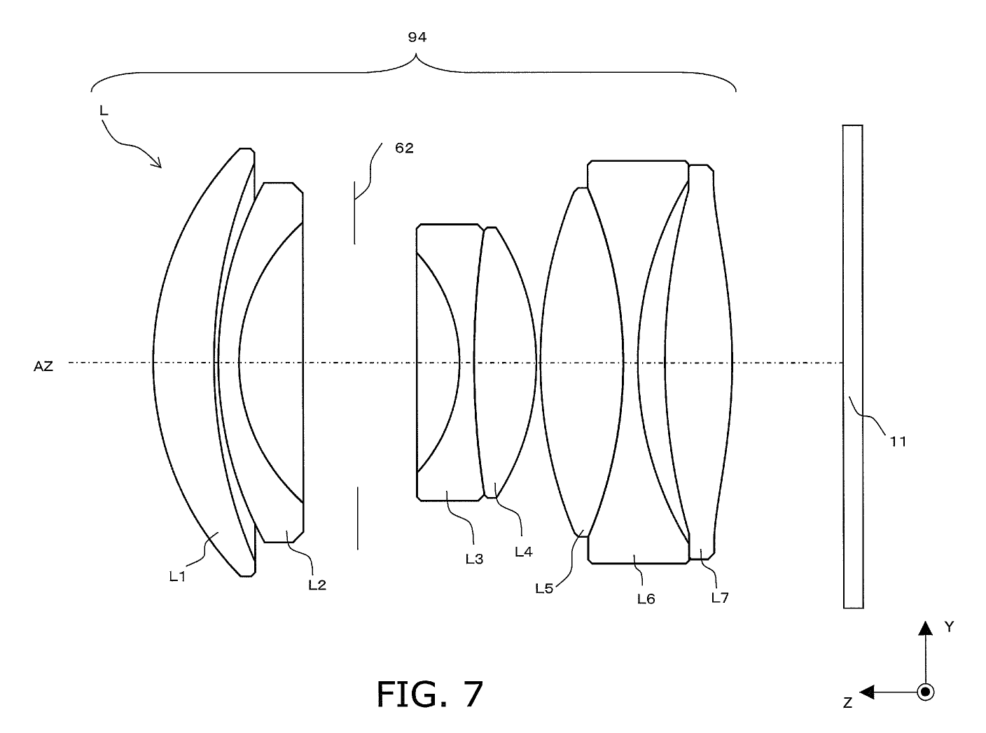

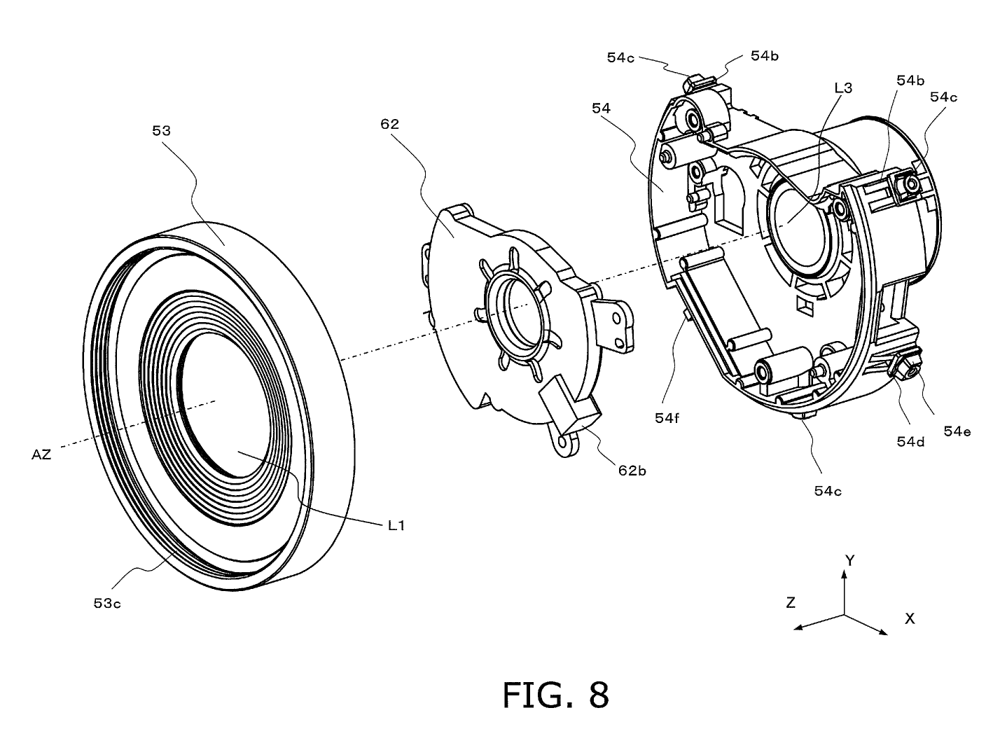

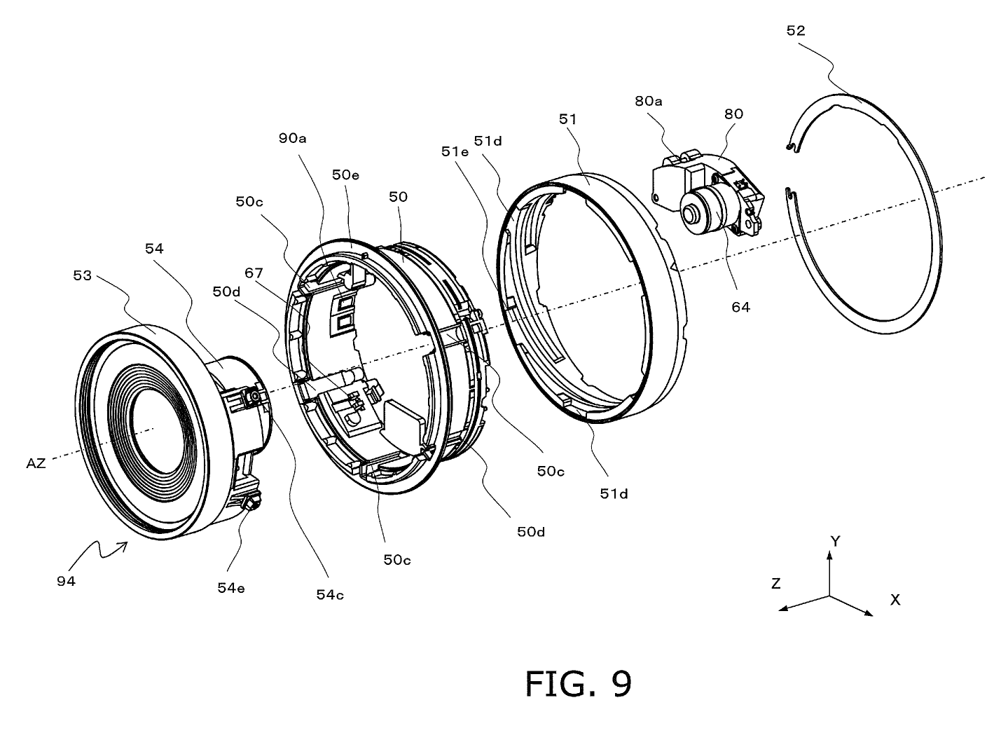

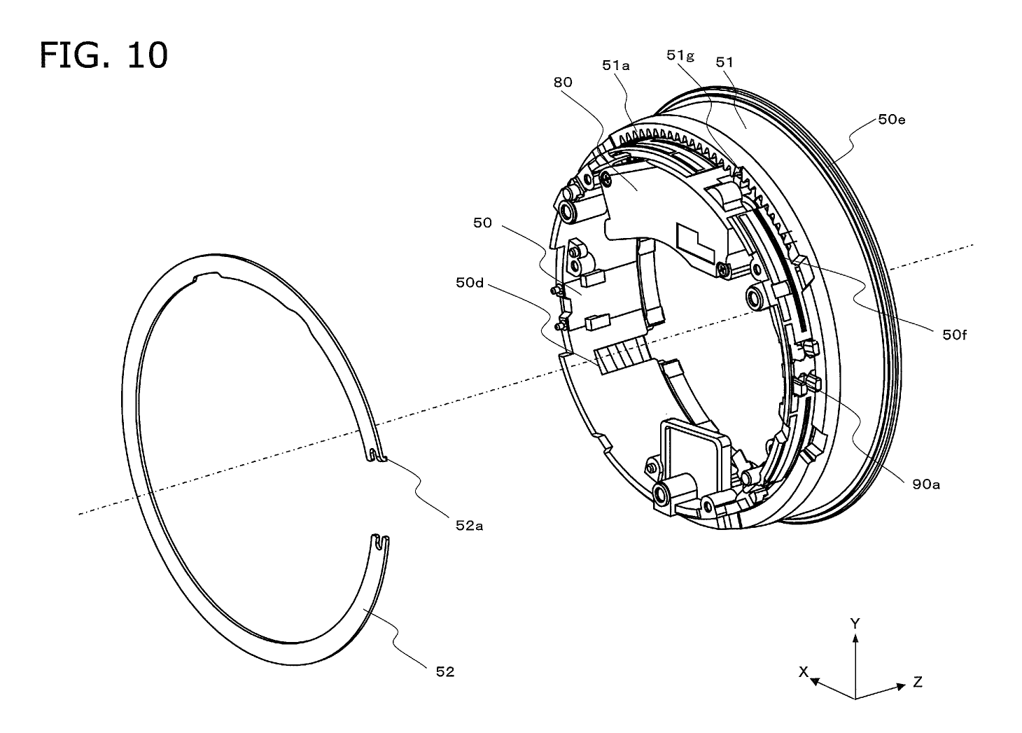

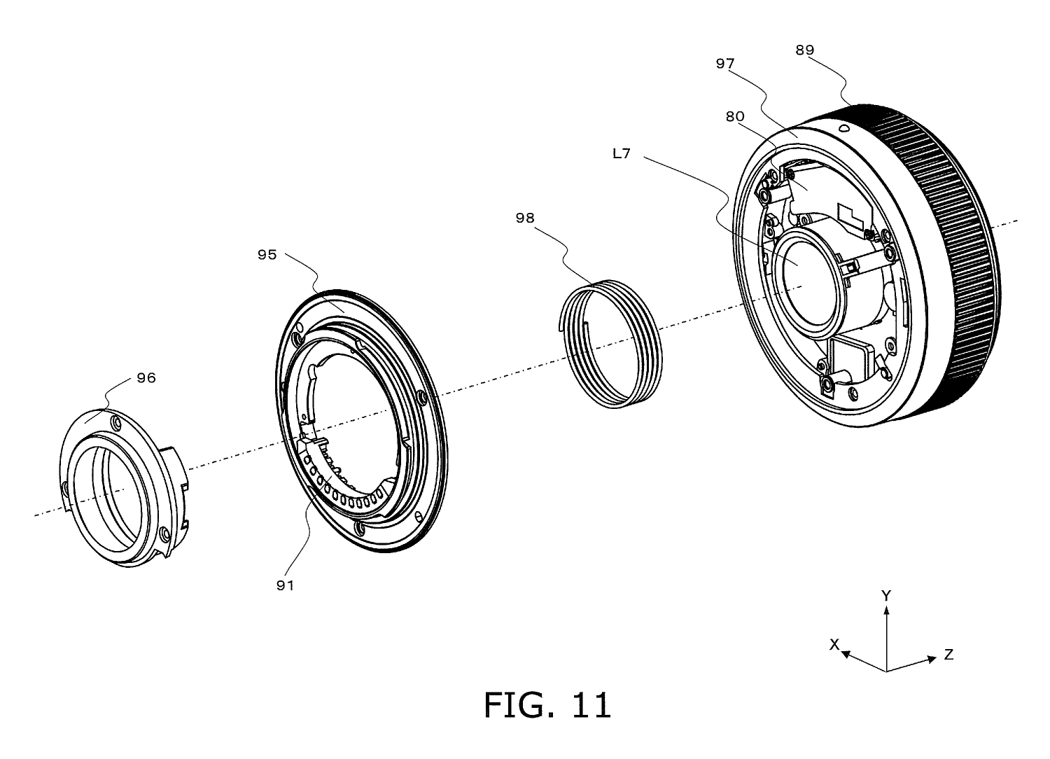

FIG. 2 is a block diagram of the configuration of the camera body 3. FIG. 3 is an oblique view of the digital camera 1. FIG. 4A is a top view of the camera body 3, and FIG. 4B is a rear view of the camera body 3. FIG. 5 is an oblique view of the interchangeable lens unit 2. FIG. 6 is a cross section of the interchangeable lens unit 2. FIG. 7 is a diagram of the configuration of an optical system L. FIG. 8 is an exploded oblique view of an aperture unit 62 and its surrounding parts. FIG. 9 is an exploded oblique view of a cam barrel 51 and its surrounding parts. FIG. 10 is another exploded oblique view of the cam barrel 51 and its surrounding parts. FIG. 11 is an exploded oblique view of a spring 98 (one example of a biasing member) and its surrounding parts.

In this embodiment, a three-dimensionally perpendicular coordinate system is set with respect to the digital camera 1. The optical axis AZ direction of the optical system L (discussed below) coincides with the Z axis direction. The X axis direction coincides with the horizontal direction when the digital camera 1 is in its landscape orientation position. The Y axis direction coincides with the vertical direction when the digital camera 1 is in its landscape orientation position. In the following description, “front” means the subject side of the digital camera 1 (the Z axis direction positive side), and “rear” means the opposite side from the subject side of the digital camera 1 (the user side or the Z axis direction negative side).

Interchangeable Lens Unit

The configuration of the interchangeable lens unit 2 will be described through reference to FIGS. 1 to 11. As shown in FIG. 1, the interchangeable lens unit 2 has the optical system L, a lens support mechanism 71 that supports the optical system L, a focus adjusting unit 72, an aperture adjusting unit 73, and a lens microprocessor 40. Each of these will be described in detail below.

(1) Optical System

The optical system L is a lens system for forming an optical image of a subject. More specifically, as shown in FIG. 7, the optical system L has seven lenses. The first lens L1 is a meniscus lens having its convex side facing the subject side. The second lens L2 is a meniscus lens having its convex side facing the subject. The opposing side of the second lens L2, which faces the imaging sensor 11, is aspherical. The third lens L3 is a biconcave lens. The fourth lens L4 is a biconvex lens and is bonded to the third lens L3 via an adhesive layer. The fifth lens L5 is a biconvex lens. The sixth lens L6 is a biconcave lens and is bonded to the fifth lens L5 via an adhesive layer. The seventh lens L7 is a biconvex lens, and the faces of the seventh lens L7 on the subject side and the imaging sensor 11 side are both aspherical.

The aperture unit 62 is located between the second lens L2 and the third lens L3.

The optical system L is not a so-called zoom lens, but rather a fixed focal lens. That is, the optical system L has a fixed focal distance.

During focusing from an infinity focal state to a close-up focal state, the optical system L and the aperture unit 62 maintain a constant distance between each other and move integrally towards the subject side. Conversely, during focusing from a close-up focal state to an infinity focal state, the optical system L and the aperture unit 62 maintain a constant distance between each other and move integrally towards the user side. That is, in this embodiment, the optical system L as a whole is a focusing lens. A focusing lens is a lens that moves in the optical axis direction in order to change and/or adjust the focal state of an optical image of a subject. The unit is composed of the optical system L and the aperture unit 62 that moves integrally during focusing is a movable focusing unit 94 (one example of a focusing lens).

(2) Lens Support Mechanism

The lens support mechanism 71 is for supporting the movable focusing unit 94 so that it is movable in the Z direction, and as shown in FIG. 6, it has the lens mount 95, a fixed frame 50, a cam barrel 51, a thrust ring 52, a first lens group support frame 53, a second lens group support frame 54, a focus ring unit 88, and the biasing member 98. Each of these will be described in detail below.

The lens mount 95 is mounted to the body mount 4 of the camera body 3 and has a lens-side contact 91. A light blocking frame 96 that blocks out unwanted light is attached to the lens mount 95 (FIGS. 6 and 11).

The fixed frame 50 is a member that rotatably supports the cam barrel 51 and is fixed to the lens mount 95. The fixed frame 50 has a substantially cylindrical shape whose center axis is the optical axis AZ. Formed on the interior of the fixed frame 50 are three linear through-grooves 50c disposed at an equal pitch (in the circumferential direction) around the optical axis AZ. The linear through-grooves 50c each have a shape that extends in the Z axis direction. Also formed on the interior of the fixed frame 50 is a linear auxiliary through-groove 50d at a phase position that is in between two of the linear through-grooves 50c, that is, at a position that is in between two of the linear through-grooves 50c around the optical axis AZ (in the circumferential direction) (FIG. 9). Two of these linear auxiliary through-grooves 50d are formed in the fixed frame 50. The linear auxiliary through-grooves 50d each extend in the Z axis direction. A groove 50f into which the thrust ring 52 is inserted and fixed is formed in the fixed frame 50 (FIG. 10). The width of the groove 50f is slightly greater than the thickness of the thrust ring 52.

The cam barrel 51 has a substantially cylindrical shape whose center axis coincides with the optical axis AZ. Formed on the interior of the cam barrel 51 are three cam grooves 51d disposed at an equal pitch (in the circumferential direction) around the optical axis AZ. The cam grooves 51d each extend in both the circumferential direction and the Z axis direction. Also formed on the interior of the cam barrel 51 is an auxiliary cam groove 51e at a phase position that is in between two of the cam grooves 51d, that is, at a position that is in between two of the cam grooves 51d around the optical axis AZ (in the circumferential direction). Two of these auxiliary cam grooves 51e are formed in the fixed frame 50. In the cam barrel 51, a gear 51a that receives the rotational drive force of a focus motor 64 is formed, and a stopper 51g that defines the end of rotation of the cam barrel 51 is formed (FIG. 10). The front side of the cam barrel 51 is in contact with a flange 50e of the fixed frame 50, and the rear side is in contact with the thrust ring 52. The cam barrel 51 is supported so that it is rotatable with respect to the fixed frame 50 and does not move in the optical axis direction.

As shown in FIG. 10, the thrust ring 52 has a shape in which part of the circular ring is cut out, that is, an arc shape, and its inside diameter is slightly smaller than the outside diameter of the fixed frame 50. The thrust ring 52 is engaged with and fixed to the groove 50f that is formed in the fixed frame 50. Near the part of the thrust ring 52 where the circular ring that is cut out, an end portion 52a of the thrust ring 52 is bent along the Z-axis direction. This end portion (or protrusion) 52a hits the stopper 51g of the cam barrel 51, and thereby defines the end of the region in which the cam barrel 51 can rotate.

The first lens group support frame 53 supports the first lens L1 and the second lens L2. Female threads 53c for attaching a conversion lens and an optical filter, such as a polarizing filter or a protective filter, are formed at the front of the first lens group support frame 53. Screw holes (not shown) for fastening the first lens group support frame 53 and the second lens group support frame 54 together with screws are formed in the first lens group support frame 53.

The second lens group support frame 54 supports the third lens L3, the fourth lens L4, the fifth lens L5, the sixth lens L6, and the seventh lens L7. As shown in FIG. 8, the second lens group support frame 54 has three convex components 54b disposed at an equal pitch around the optical axis AZ (in the circumferential direction), and three cam pins 54c formed so as to protrude outward in the radial direction from the three convex components 54b, respectively. The three cam pins 54c are respectively inserted into the three cam grooves 51d of the cam barrel 51. The three convex components 54b are respectively inserted into the three linear through-grooves 50c of the fixed frame 50. Since the cam grooves 51d extend in the circumferential direction and the Z axis direction, when the cam barrel 51 rotates with respect to the fixed frame 50, the cam pins 54c are guided in the Z axis direction along the cam grooves 51d. Here, since the movement in the circumferential direction of the convex components 54b inserted in the linear through-grooves 50c is restricted, the cam pins 54c do not rotate with respect to the fixed frame 50. As a result, the second lens group support frame 54 is able to move in the Z axis direction without rotating with respect to the fixed frame 50. The amount of movement of the second lens group support frame 54 in the Z axis direction with respect to the fixed frame 50 per unit amount of rotation of the cam barrel 51 with respect to the fixed frame 50 is determined by the shape of the cam grooves 51, that is, the inclination (or surface that forms a pressure angle) of the cam grooves 51d. In this embodiment, the inclination (or surface that forms the pressure angle) of the cam grooves 51d is constant over the entire range of movement of the cam pins 54c in the optical axis direction. That is, when the cam barrel 51 is seen from a plan view, the cam grooves 51d extend linearly. The first lens group support frame 53 is fixed to and moves integrally with the second lens group support frame 54.

The second lens group support frame 54 has an auxiliary convex component 54d at a phase position that is in between two of the convex components 54b, that is, at a position that is in between two of the convex components 54b around the optical axis AZ (in the circumferential direction). The second lens group support frame 54 has two of these auxiliary convex components 54d. Further, the second lens group support frame 54 has two auxiliary cam pins 54e formed so as to protrude outward in the outer radial direction from the two auxiliary convex components 54d, respectively. The two auxiliary cam pins 54e are respectively inserted into the two auxiliary cam grooves 51e of the cam barrel 51. The two auxiliary convex components 54d are respectively inserted into the two linear auxiliary through-grooves 50d of the fixed frame 50. The spacing between the auxiliary cam pins 54e and the auxiliary cam grooves 51e is greater than the spacing between the cam pins 54c and the cam grooves 51d. Also, there is a space between the auxiliary convex components 54d and the linear auxiliary through-grooves 50d. If the interchangeable lens unit 2 should be subjected to impact because it is dropped, for example, the auxiliary cam pins 54e and the auxiliary cam grooves 51e, and/or the auxiliary convex components 54d and the linear auxiliary through-grooves 50d, come into contact with each other and cushion the impact exerted on the cam pins 54c or the convex components 54b.

The focus ring unit 88 has a focus ring 89 and a focus ring angle detector 90 that detects the rotational angle of the focus ring 89. The focus ring 89 has a cylindrical shape and is rotatably supported by the fixed frame 50 and a rear frame 97 around the optical axis AZ in a state in which movement in the Z axis direction is restricted. The rotational angle and rotational direction of the focus ring 89 can be detected by the focus ring angle detector 90. In this embodiment, the focus ring angle detector 90 has two photosensors 90a. The focus ring 89 has a plurality of protrusions 89a that protrude inward in the radial direction and are equally spaced in the rotational direction. Each of these photosensors 90a has a light emitting component (not shown) and a light receiving component (not shown), and the plurality of protrusions 89a pass in between the light emitting components and the light receiving components, allowing the rotational angle and rotational direction of the focus ring 89 to be detected. It should be understood that the focus ring 89 can alternatively have another structure such as a movable lever, depending on the intended use of the disclosed embodiments.

In this embodiment, the biasing member 98 is a coil spring that biases the movable focus unit 94 in the optical axis direction. More specifically, one end of the biasing member 98 is contact with the light blocking frame 96 (which is fixed), and the other end is contact with the second lens group support frame 54, with the biasing member 98 being disposed such that it is always shorter than its natural length. Consequently, the movable focus unit 94 supported by the second lens group support frame 54 and the first lens group support frame 53, which moves integrally with the second lens group support frame 54, is always in a state of being biased forward, so it is less likely that the optical system L will become tilted due to looseness between the cam pins 54c and the cam grooves 51d, or the like, and this is effective at improving optical performance. As shown in FIG. 11, in this embodiment the biasing member 98 is disposed such that its center coincides with the optical axis AZ, allowing the biasing member 98 to expand and contract in the Z axis direction. Even when the movable focus unit 94 comes closest to the imaging sensor 11, the length of the biasing member 98 is greater than the minimum compressed length. Furthermore, even if the movable focus unit 94 moves closest to the subject side, the biasing member 98 will still provide a specific biasing force, such as a biasing force greater than the weight of the movable focus unit 94.

(3) Focus Adjusting Unit

The focus adjusting unit 72 has the focus motor 64, a gearbox 80, a focus drive controller 41, and the photosensor 67 (an example of a position sensor). The focus motor 64 and the gearbox 80 are fixed to the fixed frame 50. The focus drive controller 41 controls the focus motor 64 according to commands from a lens microprocessor 40. The focus motor 64 is a stepping motor, for example, and outputs rotational force to the gearbox 80. The gearbox 80 changes the speed of rotation of the focus motor 64, and outputs rotational force from a gearbox output component 80a. The gearbox output component 80a engages with the gear 51a of the cam barrel 51, and drive of the focus motor 64 rotates the cam barrel 51. That is, the cam barrel 51 is rotated by rotational force received from the gearbox output component 80a via the gear 51a. As discussed above, rotation of the cam barrel 51 is facilitated by the cam pins 54c being guided along the cam grooves 51d in the Z axis direction, and the movable focus unit 94 moves in the Z axis direction without rotating with respect to the lens mount 95. Thus, the focus motor 64 functions as a driver that outputs drive force for driving the optical system L in the optical axis direction, and the cam grooves 51d of the cam barrel 51 and the cam pins 54c of the second lens group support frame 54 function as cam mechanisms that receive the drive force outputted from the focus motor 64 and guide the optical system L in the optical axis direction.

Also, a photosensor 67 that detects the home position of the movable focus unit 94 in the optical axis direction is fixed to the fixed frame 50. This photosensor 67 has a light emitting component (not shown) and a light receiving component (not shown). When a focus home point detected component 54f of the second lens group support frame 54 passes between the light emitting component and the light receiving component, that is, when the focus home point detected component 54f is at the home position, the photosensor 67 can detect the presence of the focus home point detected component 54f. In other words, the photosensor 67 is able to detect the home position of the movable focus unit 94 with respect to the fixed frame 50.

The lens microprocessor 40 is able to control the drive speed of the focus motor 64 so as to output a drive force that will drive (or move) the movable focus unit 94 to the desired position along the Z axis direction. For instance, the lens microprocessor 40 drives the movable focus unit 94 to the home position, and recognizes from a signal from the photosensor 67 that the movable focus unit 94 is in the home position.

The home position that can be detected by the photosensor 67 is the absolute position which never changes with respect to the fixed frame 50. Accordingly, in resetting the position of the movable focus unit 94 to the home position with respect to the fixed frame 50, the focus motor 64 drives (or moves) the movable focus unit 94 to the position at which the focus home point detected component 54f for detecting the home point is detected by the photosensor 67. For example, when the power switch 25 of the digital camera 1 is turned off, the movable focus unit 94 is driven by the focus motor 64 to the position at which the focus home point detected component 54f of the second lens group support frame 54 is detected by the photosensor 67, regardless of the current position of the movable focus unit 94. Upon completion of the drive of the movable focus unit 94, the power to the digital camera 1 is switched off. Conversely, when the power switch 25 of the digital camera 1 is turned on, the movable focus unit 94 is driven to a specific position by the focus motor 64. The photosensor 67 is an example of a home detector. The home detector is not limited to being a photosensor, and can instead have a combination of a magnet and a magnetic sensor.

(4) Aperture Adjusting Unit

The aperture adjusting unit 73 has the aperture unit 62 (an example of an aperture device), an aperture drive motor that drives the aperture unit 62, and an aperture drive controller 42 that controls the aperture drive motor. The aperture drive motor is a stepping motor, for example. The aperture drive motor is driven on the basis of a drive signal inputted from the aperture drive controller 42. The drive force generated by the aperture drive motor drives aperture blades of the aperture unit 62 in the opening and closing directions, and changes the shape of the opening defined by the aperture blades. Therefore, the lens microprocessor 40 can vary the aperture value of the optical system L by driving the aperture blades via the aperture drive controller 42. In this embodiment, a photosensor 62b can detect when the opening defined by the aperture blades has a specified opening diameter. The aperture unit 62 has a positioning hole (not shown) and an anti-rotation hole (not shown). The positioning hole (not shown) and the anti-rotation hole (not shown) engage respectively with a positioning boss (not shown) and an anti-rotation boss (not shown) formed on the second lens group support frame 54, which determines the position of the aperture unit 62 in the X-Y plane. The aperture unit 62 is fixed by being fastened with screws to the second lens group support frame 54.

(5) Lens Microprocessor

The lens microprocessor 40 has a CPU (not shown), a ROM (not shown), and a memory 40a, and various functions can be performed by reading programs stored in the ROM into the CPU. For instance, the lens microprocessor 40 can recognize that the movable focus unit 94 is in the home position by using a detection signal from the photosensor 67.

The memory 40a is a nonvolatile memory, and can hold stored information even when the power supply has been halted. In this embodiment, information related to the interchangeable lens unit 2 (lens information) is held in the memory 40a.

The lens microprocessor 40 has a counter 40b for counting the number of drive pulses of the focus motor 64. The counter 40b counts “+1” when the movable focus unit 94 is driven by one drive pulse to the Z axis direction positive side, and counts “−1” when the movable focus unit 94 is driven by one drive pulse to the Z axis direction negative side. The lens microprocessor 40 can thus ascertain the relative position of the movable focus unit 94 with respect to the fixed frame 50 by counting the number of drive pulses of the focus motor 64 with the counter 40b. That is, the lens microprocessor 40 can ascertain the absolute position of the movable focus unit 94 with respect to the fixed frame 50 by combining recognition of the home position by the photosensor 67 with ascertaining the relative position found by counting the number of drive pulses.

Camera Body

The configuration of the camera body 3 will be described through reference to FIGS. 1 to 4B. As shown in FIGS. 1 to 4B, the camera body 3 has a housing 3a, the body mount 4, an interface unit 39, an image acquisition component 35, an image display component 36, a viewfinder component 38, a body microprocessor 10, and a battery 22 (an example of a main power supply).

(1) Housing

The housing 3a functions as the outer part of the camera body 3. As shown in FIGS. 4A and 4B, the body mount 4 is provided to the front face of the housing 3a, and the interface unit 39 is provided to the rear and top faces of the housing 3a. More specifically, a display component 20, the power switch 25, a mode selector dial 26, a directional arrow key 27, a menu setting button 28, a set button 29, an imaging mode selector button 34, and a moving picture capture button 24 are provided to the rear face of the housing 3a. A shutter button 30 is provided to the top face of the housing 3a.

(2) Body Mount

The body mount 4 is the portion where the lens mount 95 of the interchangeable lens unit 2 is mounted, and has a body-side contact (not shown) that can be electrically connected with the lens-side contact 91. The camera body 3 is able to send and receive data to and from the interchangeable lens unit 2 via the body mount 4 and the lens mount 95. For example, the body microprocessor 10 (discussed below) sends a control signal to the lens microprocessor 40, such as an exposure synchronization signal, via the body mount 4 and the lens mount 95.

(3) Interface Unit

As shown in FIGS. 4A and 4B, the interface unit 39 has various operating members that the user can use to input operating information. For instance, the power switch 25 is a switch for turning the power on and off to the digital camera 1 or the camera body 3. When the power is turned on with the power switch 25, power is supplied to the various parts of the camera body 3 and the interchangeable lens unit 2.

The mode selector dial 26 is used to switch the operating mode, such as still picture imaging mode, moving picture imaging mode, or play mode, and the user can turn the mode selector dial 26 to switch the operating mode. When the still picture imaging mode is selected with the mode selector dial 26, the operating mode is switched to the still picture imaging mode, and when the moving picture imaging mode is selected with the mode selector dial 26, the operating mode is switched to the moving picture imaging mode. In the moving picture imaging mode, basically moving picture imaging is possible. When the play mode is selected with the mode selector dial 26, the operating mode is switched to the play mode, allowing the captured image to be displayed on the display component 20.

The directional arrow key 27 is a button for the user to select the left, right, up, and down directions. The user can use the directional arrow key 27 to select the desired menu from various menu screens displayed on the display component 20, for example.

The menu setting button 28 is for setting the various operations of the digital camera 1. The set button 29 is for executing the operations corresponding to the various menus.

The moving picture imaging button 24 is for starting and stopping the capture of moving pictures. Even if the operating mode selected with the mode selector dial 26 is the still picture imaging mode or the play mode, when the moving picture imaging button 24 is pressed, the operating mode is forcibly changed to the moving picture imaging mode, and moving picture imaging begins, regardless of the setting on the mode selector dial 26. When this moving picture imaging button 24 is pressed during the capture of a moving picture, the moving picture imaging ends and the operating mode changes to the one selected on the mode selector dial 26, that is, to the one prior to the start of moving picture imaging. For example, if the still picture imaging mode has been selected with the mode selector dial 26 when the moving picture imaging button 24 is pressed, the operating mode automatically changes to the still picture imaging mode after the moving picture imaging button 24 is pressed again.

The shutter button 30 is pressed by the user to capture an image. When the shutter button 30 is pressed, a timing signal is outputted to the body microprocessor 10. The shutter button 30 is a two-stage switch that can be pressed half way down or all the way down. Light measurement and ranging are commenced when the user presses the button half way down. When the user presses the shutter button 30 all the way down in a state in which the shutter button 30 has been pressed half way down, a timing signal is outputted, and image data is acquired by the image acquisition component 35.

As shown in FIG. 2, a lens removal button 99 for removing the interchangeable lens unit 2 from the camera body 3 is provided to the front face of the camera body 3. The lens removal button 99 has a contact (not shown) that is in its “on” state when the button is pressed by the user, for example, and is electrically connected to the body microprocessor 10. When the lens removal button 99 is pressed, the built-in contact is switched on, and the body microprocessor 10 recognizes that the lens removal button 99 has been pressed.

(4) Image Acquisition Component

The image acquisition component 35 mainly includes the imaging sensor 11 (an example of an imaging element), a shutter unit 33 that adjusts the exposure state of the imaging sensor 11, a shutter controller 31 that controls the drive of the shutter unit 33 on the basis of a control signal from the body microprocessor 10, and an imaging sensor drive controller 12 that controls the operation of the imaging sensor 11 on the basis of a control signal from the body microprocessor 10.

The imaging sensor 11 in this embodiment is a CCD (charge coupled device) sensor that converts the optical image formed by the optical system L into an electrical signal. The imaging sensor 11 is controlled so as to be driven by a timing signal produced by the imaging sensor drive controller 12. The imaging sensor 11 can instead be a CMOS (complementary metal oxide semiconductor) sensor.

The shutter controller 31 drives a shutter drive actuator 32 and operates the shutter unit 33 according to a control signal outputted from the body microprocessor 10 that has received a timing signal.

The auto-focus method that is employed in this embodiment is a contrast detection method that makes use of image data produced by the imaging sensor 11. Using a contrast detection method allows high-precision focal adjustment.

(5) Body Microprocessor

The body microprocessor 10 is a control device that is the command center of the camera body 3, and controls the various components of the digital camera 1 according to operation information inputted to the interface unit 39. More specifically, the body microprocessor 10 is equipped with a CPU, ROM, and RAM, and the programs held in the ROM are read by the CPU, allowing the body microprocessor 10 to perform a variety of functions. For instance, the body microprocessor 10 has the function of detecting that the interchangeable lens unit 2 has been mounted to the camera body 3, and the function of acquiring information that is necessary for controlling the digital camera 1, such as information about the focal distance from the interchangeable lens unit 2.

The body microprocessor 10 is able to receive signals from the power switch 25, the shutter button 30, the mode selector dial 26, the directional arrow key 27, the menu setting button 28, and the set button 29. Different information related to the camera body 3 is held in a memory 10a inside the body microprocessor 10. The memory 10a is a nonvolatile memory and can hold stored information even when the power supply has been halted.

Also, the body microprocessor 10 periodically produces a vertical synchronization signal, and produces an exposure synchronization signal on the basis of the vertical synchronization signal in parallel with the production of the vertical synchronization signal. The body microprocessor 10 can produce an exposure synchronization signal because the body microprocessor 10 ascertains beforehand the exposure start timing and the exposure stop timing based on the vertical synchronization signal. The body microprocessor 10 outputs a vertical synchronization signal to a timing generator (not shown), and outputs an exposure synchronization signal at a specific period to the lens microprocessor 40 via the body mount 4 and the lens mount 95. The lens microprocessor 40 acquires position information about the movable focus unit 94 in synchronization with the exposure synchronization signal.

The imaging sensor drive controller 12 produces an electronic shutter drive signal and a read signal of the imaging sensor 11 at a specific period on the basis of the vertical synchronization signal. The imaging sensor drive controller 12 drives the imaging sensor 11 on the basis of the electronic shutter drive signal and the read signal. That is, the imaging sensor 11 outputs to a vertical transfer component (not shown) the pixel data produced by numerous opto-electrical conversion elements (not shown) present in the imaging sensor 11, according to the read signal.

The body microprocessor 10 also controls the focus adjusting unit 72 via the lens microprocessor 40.

The image signal outputted from the imaging sensor 11 is successively processed by an analog signal processor 13, an A/D converter 14, a digital signal processor 15, a buffer memory 16, and an image compressor 17. The analog signal processor 13 subjects the image signal outputted from the imaging sensor 11 to gamma processing or other such analog signal processing. The A/D converter 14 converts the analog signal outputted from the analog signal processor 13 into a digital signal. The digital signal processor 15 subjects the image signal converted into a digital signal by the A/D converter 14 to digital signal processing such as noise elimination or contour enhancement. The buffer memory 16 is a RAM (Random Access Memory), and temporarily stores the image signal. The image signal stored in the buffer memory 16 is sent to and processed by first the image compressor 17 and then an image recorder 18. The image signal stored in the buffer memory 16 is read at a command from an image recording controller 19 and sent to the image compressor 17. The data of the image signal sent to the image compressor 17 is compressed according to a command from the image recording controller 19. This compression adjusts the image signal to a smaller data size than that of the original data. An example of the method for compressing the image signal is the JPEG (Joint Photographic Experts Group) method in which compression is performed on the image signal for each frame. After this, the compressed image signal is recorded in the image recorder 18 by the image recording controller 19. When a moving picture is recorded, JEPG can be used, in which compression is performed on an image signal corresponding to one frame, and an H.264/AVC method can also be used, in which compression is performed on image signals corresponding to some frames all at once.

The image recorder 18 produces a still picture file or moving picture file which includes specific information to be recorded and the image signal associated with the specific information to be recorded, on the basis of a command from the image recording controller 19. The image recorder 18 also records the still picture file or moving picture file on the basis of a command from the image recording controller 19. The image recorder 18 is a removable memory and/or an internal memory, for example. The specific information to be recorded with the image signal includes the date and time information when the image was captured, focal distance information, shutter speed information, aperture value information, and imaging mode information. Still picture files are in Exif® format or a format similar to Exif® format, for example. Moving picture files are in H.264/AVC format or a format similar to H.264/AVC format, for example.

(6) Image Display Component

The image display component 36 has the display component 20 and an image display controller 21. The display component 20 is a liquid crystal monitor, for example. The display component 20 displays as a visible image the image signal recorded to the buffer memory 16 or the image recorder 18 on the basis of a command from the image display controller 21. Possible display modes on the display component 20 include a display mode in which only the image signal is displayed as a visible image, and a display mode in which the image signal and information about the time of capture of the image signal are displayed as a visible image.

(7) Viewfinder

The viewfinder component 38 has a liquid crystal viewfinder 8 that displays the image acquired by the imaging sensor 11, and a viewfinder eyepiece window 9 provided to the rear face of the housing 3a. The user looks into the viewfinder eyepiece window 9 to view the image displayed on the liquid crystal viewfinder 8.

(8) Battery

The battery 22 supplies power to the various components of the camera body 3, and also supplies power to the interchangeable lens unit 2 via the lens mount 95. In this embodiment, the battery 22 is a rechargeable battery. The battery 22 can also be a dry cell, or an external power supply can be used, with which power is supplied from the outside through a power cord.

Operation of Digital Camera

The operation of the digital camera 1 will be described.

(1) Imaging Mode

This digital camera 1 has two imaging modes. More specifically, the digital camera 1 has a viewfinder imaging mode in which the user looks at the subject through the viewfinder eyepiece window 9, and a monitor imaging mode in which the user looks at the subject on the display component 20.

In viewfinder imaging mode, for example, the image display controller 21 drives the liquid crystal viewfinder 8. As a result, an image of the subject acquired by the imaging sensor 11 (a so-called through-image) is displayed on the liquid crystal viewfinder 8.

In monitor imaging mode, for example, the display component 20 is driven by the image display controller 21, and a real-time image of the subject is displayed on the display component 20. An imaging mode selector button 34 allows switching between these two imaging modes.

(2) Still Picture Imaging

When the user presses the shutter button 30 all the way down, a command is sent from the body microprocessor 10 to the lens microprocessor 40 so that the aperture value of the optical system L will be set to the aperture value calculated on the basis of the light measurement output of the imaging sensor 11. The aperture drive controller 42 is controlled by the lens microprocessor 40, and the aperture unit 62 is stopped down to the indicated aperture value. Simultaneously with the indication of the aperture value, a drive command is sent from the imaging sensor drive controller 12 to the imaging sensor 11, and a drive command is sent from the shutter controller 31 to the shutter unit 33. The imaging sensor 11 is exposed by the shutter unit 33 for a length of time corresponding to the shutter speed calculated on the basis of the light measurement output of the imaging sensor 11.

The body microprocessor 10 executes imaging processing and, when the imaging is completed, sends a control signal to the image recording controller 19. The image recorder 18 records an image signal to an internal memory and/or removable memory on the basis of the command of the image recording controller 19. The image recorder 18 records imaging mode information (whether the auto-focus imaging mode or the manual focus imaging mode was used) and the image signal to the internal memory and/or removable memory on the basis of the command of the image recording controller 19.

Upon completion of the exposure, the imaging sensor drive controller 12 reads image data from the imaging sensor 11, and after specific image processing, image data is outputted via the body microprocessor 10 to the image display controller 21. Consequently, the captured image is displayed on the display component 20.

Also, upon completion of the exposure, the shutter unit 33 is reset to its initial position by the body microprocessor 10. The body microprocessor 10 issues a command to the lens microprocessor 40 for the aperture drive controller 42 to reset the aperture 62 to its open position, and a reset command is sent from the lens microprocessor 40 to the various units. Upon completion of this resetting, the lens microprocessor 40 tells the body microprocessor 10 that resetting is complete. After the resetting completion information has been received from the lens microprocessor 40, and after a series of post-exposure processing has been completed, the body microprocessor 10 confirms that the shutter button 30 has not been pressed, and the imaging sequence is concluded.

(3) Moving Picture Imaging

The digital camera 1 also has the function of capturing moving pictures. In the moving picture imaging mode, image data is produced by the imaging sensor 11 at a specific period, and the image data thus produced is utilized to continuously carry out auto-focusing by the contrast detection method. In the moving picture imaging mode, if the shutter button 30 is pressed, or if the moving picture imaging button 24 is pressed, a moving picture is recorded to the image recorder 18, and when the shutter button 30 or the moving picture imaging button 24 is pressed again, recording of the moving picture by the image recorder 18 is stopped.

(4) Contrast AF Operation

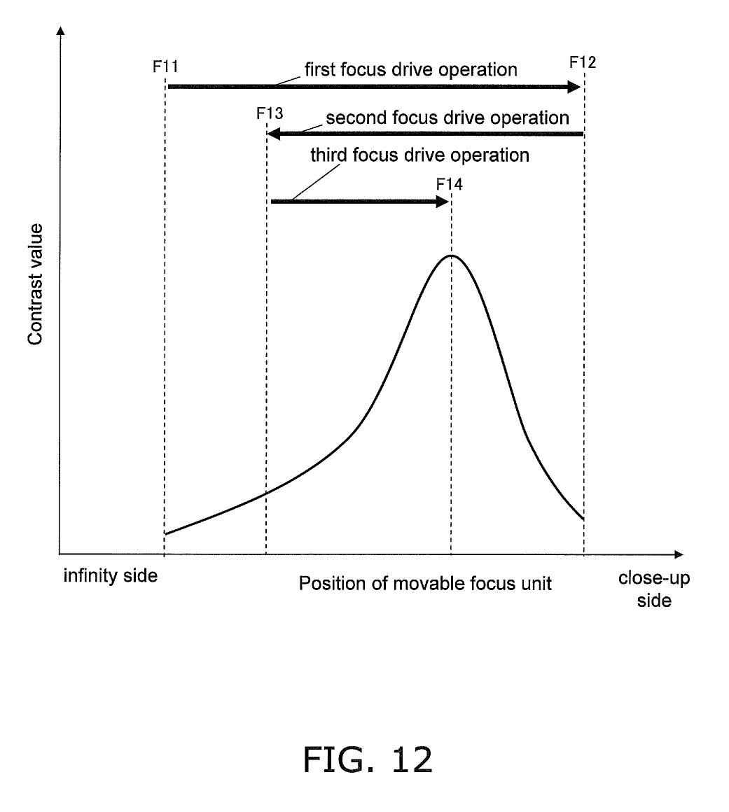

Auto-focus operation of the digital camera 1 by contrast detection (contrast AF) will now be described through reference to FIGS. 12 to 14. FIG. 12 is a diagram illustrating contrast AF operation. The vertical axis in FIG. 12 is the contrast value, and the greater the contrast value, the better the focus. The horizontal axis in FIG. 12 is the position of the movable focus unit 94 in the optical axis direction; moving to the right of the graph, there image of the subject is moving increasingly closer (i.e., the movable focus unit 94 is on the subject side), and moving to the left, the image of the subject is moving increasingly to infinity (i.e., the movable focus unit 94 is on the user side).

When the shutter button 30 is pushed half-way down by the user, a timing signal is sent to the body microprocessor 10, and the digital camera 1 changes to contrast AF operation.

When the camera changes to contrast AF operation, the digital camera 1 performs a first focus drive operation, in which the peak contrast value is detected and the focal position is predicted. More specifically, in the first focus drive operation, the body microprocessor 10 issues commands to the lens microprocessor 40 for the speed of the focus motor 64 (contrast detection speed) and the detection end position F12, which is the target position to which the movable focus unit 94 is to be moved. The contrast detection speed, which is the speed of the focus motor 64 indicated by the body microprocessor 10 during the first focus drive operation, is a speed at which the body microprocessor 10 can accurately predict the focal position, and in this embodiment, it is faster than the “set speed” discussed below. As a result, in step S4 discussed below, the actual drive speed of the focus motor 64 during the first focus drive operation becomes the “set speed” discussed below. The lens microprocessor 40 sends a command to the focus drive controller 41 on the basis of the command from the body microprocessor 10, and the focus motor 64 is driven by the focus drive controller 41. The focus motor 64 moves the movable focus unit 94 from the detection start position F11 to the detection end position F12 via the gearbox 80, the cam barrel 51, and the second lens group support frame 54. While the movable focus unit 94 is being moved from the detection start position F11 to the detection end position F12, the imaging sensor 11 outputs image data for each timing interval of the exposure synchronization signal. The body microprocessor 10 detects the contrast value for each image data. Furthermore, the body microprocessor 10 acquires position information about the position of the movable focus unit 94 from the lens microprocessor 40 for each timing interval of the exposure synchronization signal. The body microprocessor 10 associates the position information about the position of the movable focus unit 94 with the contrast value acquired for each timing interval of the exposure synchronization signal, and stores this in the memory 10a. The body microprocessor 10 predicts the position of the movable focus unit 94 at which the contrast value will be at its peak (the peak position F14) on the basis of the distribution of the contrast values and the position information about the position of the movable focus unit 94 (that is, it predicts the focal position). When prediction of the peak position F14 is finished, the digital camera 1 changes to a second focus drive operation. During the first focus drive operation, if the body microprocessor 10 determines that the contrast value has decreased through the movement of the movable focus unit 94, then the body microprocessor 10 reverses the direction in which the movable focus unit 94 is moved and performs the first focus drive operation over again. FIG. 12 is a diagram illustrating the operation when the focal position is more to the subject side than the initial position F11 of the movable focus unit 94. The contrast value indicates the degree of sharpness of the subject. The contrast value is an example of a value that expresses the degree of focus.

In the second focus drive operation, first the body microprocessor 10 issues commands to the lens microprocessor 40 for the speed of the focus motor 64 and the target position F13 of the movable focus unit 94, which is higher than the peak position F14 of the contrast value when viewed from the current position F12. The actual drive speed of the focus motor 64 during the second focus drive operation becomes the “set speed” discussed below. The lens microprocessor 40 drives the focus motor 64 on the basis of the command from the body microprocessor 10 and the “set speed,” and when the movable focus unit 94 reaches the target position F13, the second focus drive operation ends and changes to a third focus drive operation.

In the third focus drive operation, the body microprocessor 10 issues commands to the lens microprocessor 40 for the speed of the focus motor 64 and the peak position F14 of the contrast value (serving as a target position). The actual drive speed of the focus motor 64 during the third focus drive operation also becomes the “set speed” just as in the second focus drive operation. The lens microprocessor 40 drives the focus motor 64 on the basis of the command from the body microprocessor 10 and the “set speed,” and when the movable focus unit 94 reaches the target position F14, the third focus drive operation ends and so does contrast AF operation. The contrast value is neither calculated during the second focus drive operation nor during the third focus drive operation.

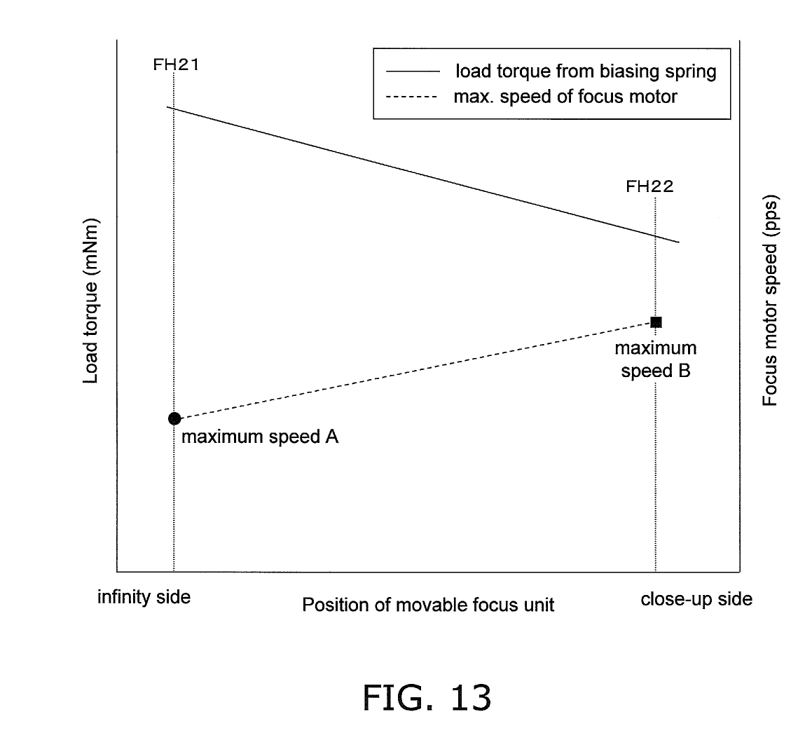

As discussed above, in the first, second, and third focus drive operations, the body microprocessor 10 sends a request to the lens microprocessor 40 for the speed of the focus motor 64 (command speed), and this command speed is determined as follows. First, if the body microprocessor 10 detects that the interchangeable lens unit 2 has been mounted to the camera body 3, it acquires from the lens microprocessor 40 information about the characteristics of the interchangeable lens unit 2, which will be necessary in the overall control of the digital camera 1. This information about the characteristics of the interchangeable lens unit 2 includes the above-mentioned focal distance information as well as information indicating the “maximum speed” of the focus motor 64, etc. The body microprocessor 10 decides the maximum speed at which the focus motor 64 will not go out of step under various restrictions, within a range that does not exceed said “maximum speed” during the drive of the movable focus unit 94, including during the first, second, and third focus drive operations. The body microprocessor 10 then issues a command to the lens microprocessor 40 regarding this speed. Meanwhile, the lens microprocessor 40 compares the maximum speed decided by the body microprocessor 10 so that the focus motor 64 will not go out of step with the “set speed”, as in step S4 discussed below, and employs the slower of the speeds as the actual drive speed for the focus motor 64. In this embodiment, the maximum speed B in FIG. 13 is sent as the “maximum speed” from the lens microprocessor 40 to the body microprocessor 10 when the interchangeable lens unit 2 is mounted to the camera body 3.

Also, the reason the movable focus unit 94 is not driven to F14, which is the peak position of the contrast value, immediately after the end of the first focus drive operation is because the gearbox 80 experiences a backlash when the direction of movement of the movable focus unit 94 is changed and as a result, error corresponding to the backlash will occur. To reduce this error caused by backlash, the focal position detection direction (first focus drive operation) and the focal position movement direction (third focus drive operation) are made to be in the same direction, so that the error corresponding to backlash is smaller. Accordingly, when there is little variance in backlash due to orientation error, repetition error, or the like, the contrast AF operation can end by moving to a target position obtained by adding a backlash correction component to the focal position F14 in the second focus drive operation.

In a contrast AF method, accurate positioning the movable focus unit 94 is required for the predicted focal position, so a stepping motor is used as the focus motor 64. With a stepping motor, the rotational angle varies with the inputted drive pulses, so the position the movable focus unit 94 can be controlled with this motor without using an external sensor, and stepping motors are widely used for digital cameras that employ contrast AF. However, if the resistance to rotation (load torque) is too great, or the drive speed (output torque) of the focus motor 64 is too high, synchronization is lost between the number of drive pulses and the rotational angle (the drive is out of step). Accordingly, the drive speed (output torque) of the focus motor 64 must be set extra low to take into account the load torque, temperature characteristics, and so forth.

When the movable focus unit 94 is biased by the biasing member 98 as in this embodiment, the biasing force on the movable focus unit 94 is used as load torque on the focus motor 64 in the movement of the movable focus unit 94 in the optical axis direction. The biasing force on the movable focus unit 94 varies according to the position of the movable focus unit 94 in the optical axis direction. That is, the load torque of the biasing member 98 varies according to the position of the movable focus unit 94 in the optical axis direction. Accordingly, for example, a method can be used in which the speed of the stepping motor at which the drive of the focus motor 64 does not go out of step is set as the “set speed,” using the point at which the load torque of the movable focus unit 94 is at its maximum as a reference. With this method, when the movable focus unit 94 is moved at high speed to the target position, the movable focus unit 94 is driven at the constant “set speed” regardless of the position of the movable focus unit 94 in the optical axis direction. In this embodiment, though, the “set speed” of the focus motor 64 is made variable according to the position of the movable focus unit 94 in the optical axis direction as discussed below, so that the actual drive speed of the focus motor 64 is made variable according to the position of the movable focus unit 94 in the optical axis direction, and a higher focusing speed is attained.

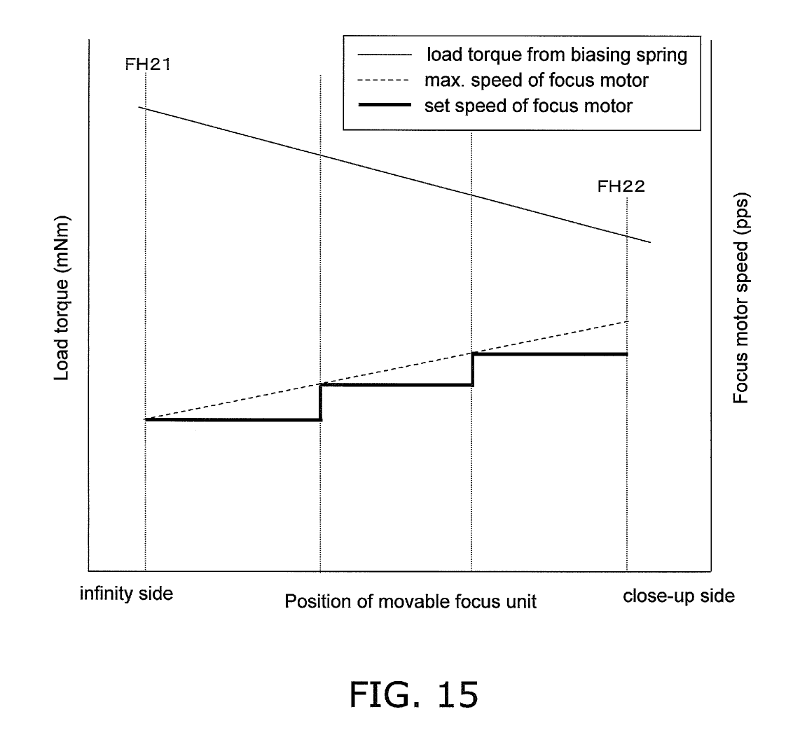

FIG. 13 is a graph showing the relationship between the load torque produced by the biasing member 98 and the maximum speed of the focus motor 64 at which the drive does not go out of step even under such load torque, within the range of movement of the movable focus unit 94 in the optical axis direction. As shown in FIG. 13, when the movable focus unit 94 is positioned to focus on a subject on the infinity side, the biasing member 98 is greatly compressed and the magnitude of the load torque is large, and when the movable focus unit 94 is positioned to focus on a subject on the close-up side, compression of the biasing member 98 is reduced and the magnitude of the load torque is small. Specifically, the load torque is greater when the movable focus unit 94 is at position FH21 than when the movable focus unit 94 is at position FH22. Accordingly, when the movable focus unit 94 is at the position FH21, the maximum speed A is lower than the maximum speed B when the movable focus unit 94 is at the position FH22. As a result, as shown in FIG. 15, when the movable focus unit 94 is in the position FH21, the “set speed” is set lower than when the movable focus unit 94 is in the position FH22. To put this another way, when the movable focus unit 94 is at the position FH22, a higher speed is achieved by setting the “set speed” at a higher “set speed” than when the movable focus unit 94 is in the position FH21.

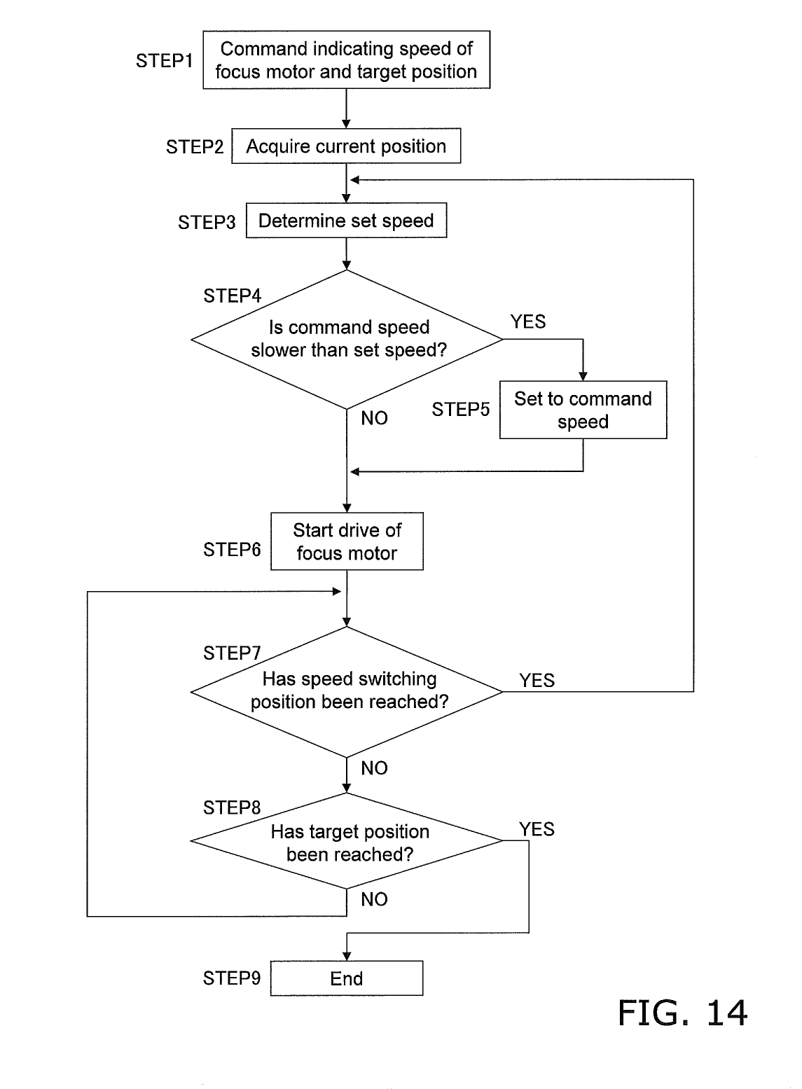

FIG. 14 shows a flowchart of the process related to a variable set speed method, and FIG. 15 shows an example of a speed switching table. In this embodiment, processing by the following variable set speed method is used in the above-mentioned first focus drive operation, second focus drive operation, and third focus drive operation.

First, the speed of the focus motor 64 and the target position are indicated by command from the body microprocessor 10 to the lens microprocessor 40 (step 1). The target position is, for example, the target position F12 in the first focus drive operation, the target position F13 in the second focus drive operation, or the target position F14 in the third focus drive operation.

Next, the lens microprocessor 40 acquires the current position of the movable focus unit 94 (step 2). More specifically, the current position of the movable focus unit 94 is acquired by counting the number of drive pulses of the focus motor 64 after ascertaining the absolute position of the movable focus unit 94 as discussed above.

The lens microprocessor 40 then determines the “set speed” of the focus motor 64 corresponding to the current position on the basis of a speed switching table (step 3). A speed switching table shows the corresponding relationship between the “set speed” and the position of the movable focus unit 94 in the optical axis direction. The actual drive speed of the focus motor 64 is determined to be the “set speed” when the “set speed” is equal to or less than the command speed from the body microprocessor 10, as in step S4 discussed below, and is the “set speed” during the first, second, and third focus drive operations. Therefore, a speed switching table is information that expresses the corresponding relationship between the actual drive speed of the focus motor 64 and the position of the movable focus unit 94 in the optical axis direction. The “set speed” is defined for each position of the movable focus unit 94 as the speed at which the drive of the focus motor 64 does not go out of step. The “set speed” is also a value that varies according to the position of the movable focus unit 94. More specifically, the “set speed” is lower when the load torque is greater and is higher when the load torque is less. The speed switching table is stored in the memory 40a.

The lens microprocessor 40 compares the driving speed indicated by the body microprocessor 10 (an example of the command speed) with the “set speed” determined in step 3. If the driving speed or command speed is the same as the “set speed” of the focus motor 64, or is higher than the “set speed,” then the actual drive speed of the focus motor 64 is set to the “set speed” of the focus motor 64, and the flow proceeds to step 6. If the driving speed or command speed is slower than the “set speed” of the focus motor 64, then the flow proceeds to step 5 (step 4). In step 5, the lens microprocessor 40 sets the actual drive speed of the focus motor 64 to the command speed from the body microprocessor 10, and the flow proceeds to step 6.

The lens microprocessor 40 then drives the focus motor 64 at the set drive speed (step 6). More specifically, the number of drive pulses per unit of time transmitted to the focus motor 64 is made to correspond with the set drive speed.

The lens microprocessor 40 monitors the position of the movable focus unit 94, determines whether or not the focus motor 64 has reached the speed switching position in the speed switching table of FIG. 15 (the position at which the “set speed” changes), and if the speed switching position has been reached, the flow proceeds to step 3, but if it has not been reached, the flow proceeds to step 8 (step 7). The lens microprocessor 40 acquires the current position of the movable focus unit 94 by counting the number of drive pulses after ascertaining the absolute position of the movable focus unit 94.

In step 8, the lens microprocessor 40 determines whether or not the movable focus unit 94 has reached the target position indicated by the body microprocessor 10. If the movable focus unit 94 has not reached the target position, the flow proceeds to step 7, but if it has reached the target position, the flow proceeds to step 9 and the lens microprocessor 40 halts the focus motor 64. The lens microprocessor 40 acquires the current position of the movable focus unit 94 by counting the number of drive pulses after ascertaining the absolute position of the movable focus unit 94.

With the variable set speed method discussed above, the focus motor 64 that drives the focusing lens can be prevented from going out of step, while the movement speed of the movable focus unit 94 (or the focusing lens) can be increased.

### Second Embodiment

Only those points that differ from the first embodiment will be described, and description of points that are the same will be omitted.

The interchangeable lens unit 2 in the first embodiment had the biasing member 98, but the interchangeable lens unit 2 in the second embodiment does not have the biasing member 98.

Also, the cam grooves 51d of the interchangeable lens unit 2 in the first embodiment had a constant inclination (or surface that forms the pressure angle) over the entire range of movement of the movable focus unit 94 in the optical axis direction. That is, the load torque produced by the cam grooves 51d was constant over the entire range of movement of the movable focus unit 94 in the optical axis direction. On the other hand, the cam grooves 51d of the interchangeable lens unit 2 in the second embodiment are formed such that their inclination (surface and pressure angle) varies with the position in the optical axis direction. In other words, the cam grooves 51d are formed in such a way that the amount of movement of the movable focus unit 94 in Z axis direction per unit of rotational force outputted from the focus motor 64 varies with the position of the movable focus unit 94 in the optical axis direction. That is, the load torque produced by the cam grooves 51d varies with the position of the movable focus unit 94 in the optical axis direction. Furthermore, the greater the inclination (surface and pressure angle) of the cam grooves 51d, the greater the amount of movement of the movable focus unit 94 in the Z axis direction with respect to the amount of rotation of the cam barrel 51. That is, the greater the inclination (surface and pressure angle) of the cam grooves 51d, the greater the amount of movement of the movable focus unit 94 with respect to the amount of rotation of the focus motor 64 (the same applies hereinafter).

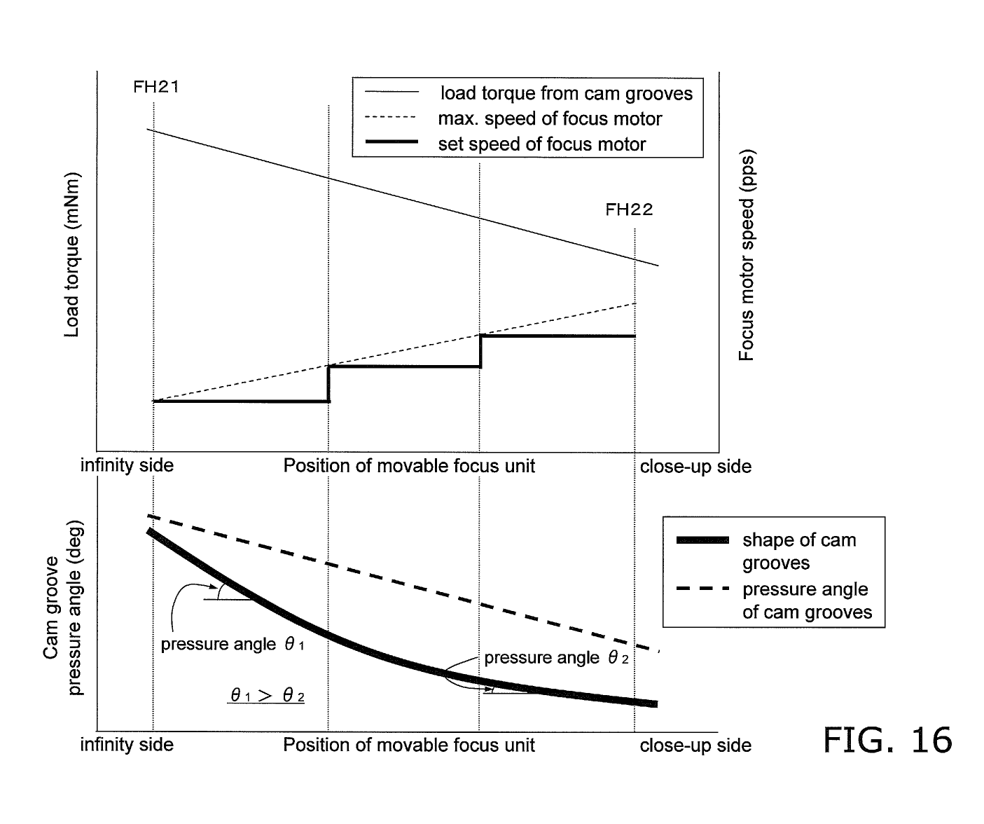

FIG. 16 is a graph showing the relationship between the set speed of the focus motor 64, the maximum speed of the focus motor 64, the load torque, the surface and/or the pressure angle of the cam grooves 51d, and the shape of the cam grooves 51d with respect to the position of the movable focus unit 94. The “shape of the cam grooves 51d” referred to here is approximately the shape of the cam grooves 51d when the cam barrel 51 is seen from a plan view.

The load torque is higher where the pressure angle of the cam grooves 51d is greater. Also, the load torque is lower where the pressure angle of the cam grooves 51d is smaller. The situation in which the load torque varies with the position of the movable focus unit 94 in the optical axis direction is the same as that in the first embodiment. And the same variable set speed method as in the first embodiment is used again in the second embodiment. Consequently, the focus motor 64 that drives the movable focus unit 94 (or the focusing lens) can be prevented from going out of step, while the movement speed of the focusing lens can be increased.

### Third Embodiment

Only those points that differ from the first embodiment will be described, and description of points that are the same will be omitted.

The cam grooves 51d of the interchangeable lens unit 2 in the first embodiment had a constant inclination (or surface that forms the pressure angle) over the entire range of movement of the movable focus unit 94 in the optical axis direction. That is, the load torque produced by the cam grooves 51d was constant over the entire range of movement of the movable focus unit 94 in the optical axis direction. On the other hand, the cam grooves 51d of the interchangeable lens unit 2 in the third embodiment extend such that their inclination (surface and pressure angle) varies with the position in the optical axis direction. In other words, the cam grooves 51d are formed in such a way that the amount of movement of the movable focus unit 94 in the Z axis direction per unit of rotational force outputted from the focus motor 64 varies with the position of the movable focus unit 94 in the optical axis direction. That is, the load torque produced by the cam grooves 51d varies with the position of the movable focus unit 94 in the optical axis direction.

The interchangeable lens unit 2 of the third embodiment also has the biasing member 98. Therefore, the load torque produced by the biasing member 98 varies with the position of the movable focus unit 94 in the optical axis direction.

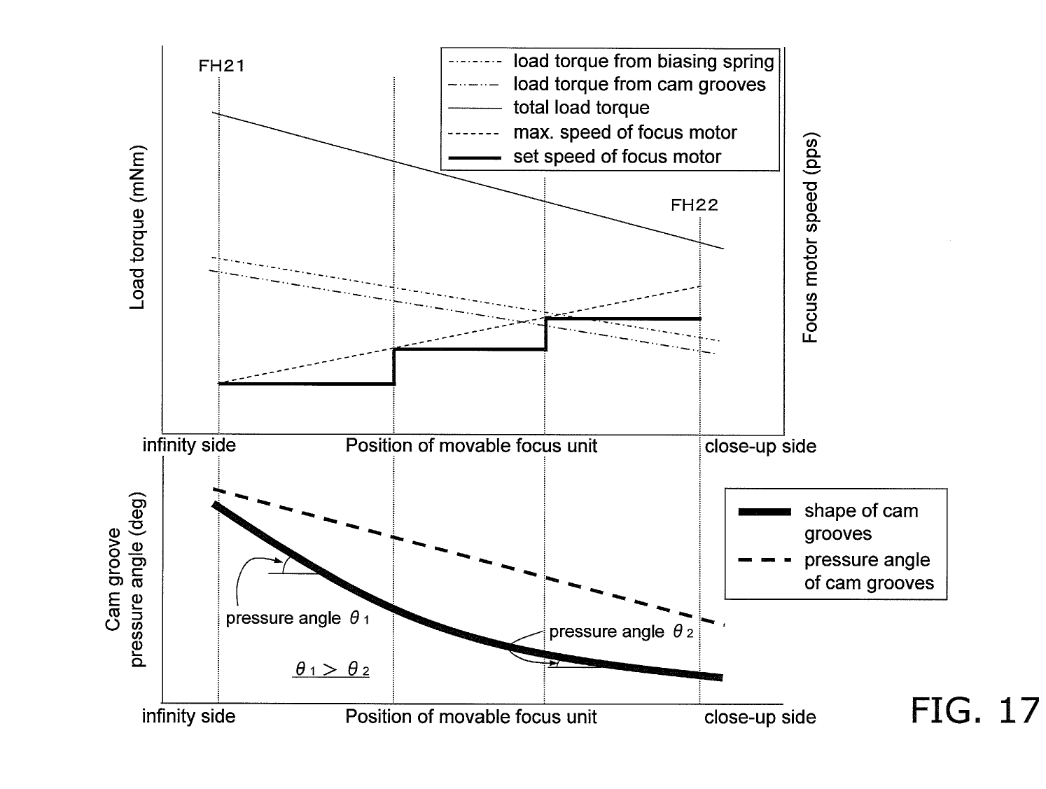

FIG. 17 is a graph showing the relationship between the set speed of the focus motor 64, the maximum speed of the focus motor 64, the load torque, the surface and/or the pressure angle of the cam grooves 51d, and the shape of the cam grooves 51d with respect to the position of the focus movable unit 94. The “shape of the cam grooves 51d” referred to here is substantially the shape of the cam grooves 51d when the cam barrel 51 is seen from a plan view.

The total load torque obtained by combining the load torque produced by the cam grooves 51d and the load torque produced by the biasing member 98 also varies with the position of the movable focus unit 94 in the optical axis direction. The situation in which the load torque varies with the position of the movable focus unit 94 in the optical axis direction is the same as that in the first embodiment. And the same variable set speed method as in the first embodiment is used again in the third embodiment. Consequently, the focus motor 64 that drives the movable focus unit 94 (or the focusing lens) can be prevented from going out of step, while the movement speed of the focusing lens can be increased.

### Fourth Embodiment

Only those points that differ from the first embodiment will be described, and description of points that are the same will be omitted.

The interchangeable lens unit 2 of the fourth embodiment also has the biasing member 98. Therefore, the load torque produced by the biasing member 98 varies with the position of the movable focus unit 94 in the optical axis direction.

The cam grooves 51d of the interchangeable lens unit 2 in the first embodiment had a constant inclination (or surface that forms the pressure angle) over the entire range of movement of the movable focus unit 94 in the optical axis direction. That is, the load torque produced by the cam grooves 51d was constant over the entire range of movement of the movable focus unit 94 in the optical axis direction. On the other hand, the cam grooves 51d of the interchangeable lens unit 2 in the fourth embodiment are formed such that their inclination (surface and pressure angle) varies with the position in the optical axis direction. In other words, the cam grooves 51d extend in such a way that the amount of movement of the movable focus unit 94 in the Z axis direction per unit of rotational force outputted from the focus motor 64 (an example of a unit output of the driver) varies with the position of the movable focus unit 94 in the optical axis direction. That is, the load torque produced by the cam grooves 51d varies with the position of the movable focus unit 94 in the optical axis direction.

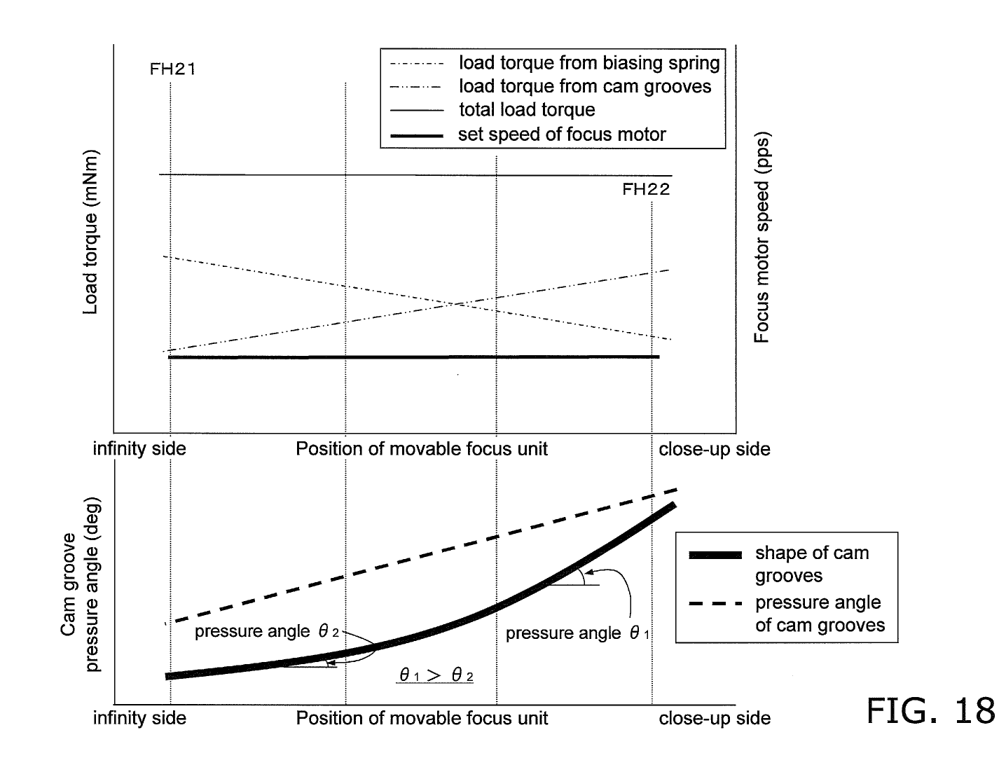

FIG. 18 is a graph showing the relationship between the set speed of the focus motor 64, the maximum speed of the focus motor 64, the load torque, the pressure angle of the cam grooves 51d, and the shape of the cam grooves 51d with respect to the position of the focus movable unit 94. The “shape of the cam grooves 51d” referred to here is substantially the shape of the cam grooves 51d when the cam barrel 51 is seen from a plan view.

In this embodiment and within the range of movement of the movable focus unit 94 in the optical axis direction, the inclination (i.e., the surface and/or the pressure angle) of the cam grooves 51d is lower at a position where the load torque produced by the biasing member 98 is relatively high; in other word, the surface and/or the pressure angle of the cam grooves 51d is lower at a position where the biasing force of the biasing member 98 is relatively large. The surface and/or the pressure angle of the cam grooves 51d is higher at a position where the load torque produced by the biasing member 98 is relatively low; in other word, the surface and/or the pressure angle of the cam grooves 51d is higher at a position where the biasing force of the biasing member 98 is relatively small. Therefore, the load torque obtained by combining the load torque produced by the cam grooves 51d and the load torque produced by the biasing member 98 fluctuate very little according to the position of the movable focus unit 94 in the optical axis direction.

In this embodiment, unlike in the first embodiment, the “set speed” of the focus motor 64 is set to be constant regardless of the position of the movable focus unit 94 in the optical axis direction. The “set speed” is set so that step-out will not occur regardless of the position of the movable focus unit 94 in the optical axis direction.

Even though the “set speed” of the focus motor 64 is set to be constant, the speed during movement of the movable focus unit 94 changes with the position of the movable focus unit 94 in the optical axis direction. That is, the speed during movement of the movable focus unit 94 changes according to the inclination (surface and/or pressure angle) of the cam grooves 51d. Of the positions of the movable focus unit 94 in the optical axis direction, the speed during movement of the movable focus unit 94 is lower at a position where the load torque produced by the biasing member 98 is high and is higher at a position where the load torque produced by the biasing member 98 is low.

Therefore, just as in the first embodiment, even when the load torque produced by the biasing member 98 changes according to the position of the movable focus unit 94, the focus motor 64 that drives the movable focus unit 94 (or the focusing lens) can still be prevented from going out of step, and the movement speed of the focusing lens can be raised.

Processing pertaining to a variable set speed method can also be executed using the flowchart in FIG. 14, by storing the speed during movement of the movable focus unit 94 with respect to the position of the movable focus unit 94 in the optical axis direction (which is affected by the inclination (surface and/or pressure angle) of the cam grooves 51d) as a speed switching table.

Also, the cam grooves 51d can be formed so that the total load torque obtained by combining the load torque produced by the cam grooves 51d and the load torque produced by the biasing member 98 is constant over the entire range of the movable focus unit 94 in the optical axis direction.

### Other Embodiments

Embodiments of the present invention are not limited to those given above and various changes and modifications are possible without departing from the gist of the present invention. Also, the embodiments given above are basically just preferred examples, and the scope of the present invention, objects that the present invention is applied to, and the use or purpose of the present invention are not limited to these embodiments.

(1)

In the above embodiments, the digital camera 1 was capable of capturing both moving and still pictures, but can instead be capable of capturing just still pictures, or just moving pictures.

(2)

In the above embodiments, the digital camera 1 can be, for example, a digital still camera, a digital video camera, a mobile telephone equipped with a camera, or a PDA equipped with a camera.

(3)

The above-mentioned digital camera 1 did not have a quick return mirror, but a quick return mirror can be installed as in a conventional single reflex lens camera. Also, the lens barrel and the camera body can be integrated in the digital camera 1.

(4)

The configuration of the optical system L is not limited to that in the embodiments. For example, the fifth lens L5 and the sixth lens L6 may not be joined together. Also, the optical system L can be a zoom lens with which the focal distance can be changed. The focusing lens can be just one part of the optical system L, rather than the entire optical system L.

(5)

In the above embodiments, the biasing member 98 was a single coil spring, and its center was disposed so as to coincide with the optical axis AZ, but a plurality of biasing members can be disposed within the X-Y plane. Also, these do not necessarily have to be coil springs. Also, the biasing member 98 can bias the movable focus unit 94 to the rear.

(6)

In the above embodiments, contrast auto-focusing was used, but with a phase difference method of auto-focusing, a variable set speed method can be employed in driving the movable focus unit 94 to the predicted focal position. More specifically, in a phase difference method of auto-focusing, the actual drive speed of the focus motor 64 can be changed according to the position of the movable focus unit 94 in the optical axis direction in driving the movable focus unit 94 to the predicted focal position.

(7)

The variable set speed method may not be used in all of the first focus drive operation, second focus drive operation, and third focus drive operation discussed above, and just in one or two of them, the variable set speed method can be used. For instance, in the first focus drive operation, it may not be used.

(8)

In the above embodiments, the “set speed” of the speed switching table was made variable in three stages, but the switching points can be set as desired, and the switching of the “set speed” can be carried out continuously.

(9)

In the above embodiments, the movable focus unit 94 was driven by a force obtained by converting the output of the focus motor 64 with a cam mechanism, but this is the only option, and the output of the focus motor 64 can be converted into the rectilinear force of a nut via a screw and nut, and the movable focus unit 94 driven by this rectilinear force. Also, the output of the focus motor 64 can be converted into some other force, and the movable focus unit 94 driven by this force.

(10)

Steps 3, 4, 5, 7, and 8 in the flowchart of processing pertaining to the variable set speed method can be executed by the body microprocessor 10 rather than by the lens microprocessor 40. For example, information in the speed switching table is sent from the lens microprocessor 40 to the body microprocessor 10 at the point when the interchangeable lens unit 2 is mounted to the camera body 3, etc. Then, in step 3, the body microprocessor 10 determines the “set speed” by referring to the speed switching table, ant then the determined “set speed” is sent from the body microprocessor 10 to the lens microprocessor 40.

(11)

In the above embodiments, during the first, second, and third focus drive operations, the speed of the focus motor 64 indicated by the body microprocessor 10 to the lens microprocessor 40 (command speed) was greater than the “set speed” that was placed in the speed switching table, and as a result, the “set speed” was employed as the actual drive speed of the focus motor 64. However, the command speed can be slower than the “set speed” in at least one of the first, second, and third focus drive operations, and as a result, the command speed can be employed rather than the “set speed” as the actual drive speed of the focus motor 64. The command speed is decided by the body microprocessor 10 as the maximum speed at which the focus motor 64 will not go out of step, according to information indicating the characteristics of the interchangeable lens unit 2. Therefore, the command speed can be slower than the “set speed” depending on the characteristics of the interchangeable lens unit 2 mounted to the camera body 3.

### Features of Embodiments

Features of the above embodiments are listed below. The inventions encompassed by the above embodiments are not limited to what is given below. The parts in parentheses which the various components are followed by are specific examples of those components given to facilitate an understanding of the features. Those components are not limited to those specific examples. Also, to obtain the effects listed for the various features, a component other than that of the discussed features can be modified or eliminated.

(F1)

The lens barrel (interchangeable lens unit 2) pertaining to the first feature includes:

a focusing lens (optical system L) that changes its state of focus by moving in the optical axis direction;

a driver (focus motor 64) that outputs a drive force for driving the focusing lens in the optical axis direction; and

a controller (lens microprocessor 40) that controls the driving speed (the “set speed” • the number of drive pulses per unit of time) of the driver,

wherein the focusing lens is subject to a load as it moves in the optical axis direction, the load is dependent upon the position of the focusing lens in the optical axis direction, and

the controller controls the driver so that when the focusing lens is at a position where the load is small the driving speed (the “set speed” • the number of drive pulses per unit of time) is larger than the driving speed (the “set speed” • the number of drive pulses per unit of time) when the focusing lens is at a position where the load is large.

With this lens barrel, the motor that drives the focusing lens can be prevented from going out of step while the movement speed of the focusing lens can be raised.

(F2)

The lens barrel pertaining to the second feature is the lens barrel pertaining to the first feature, further including a biasing member that biases the focusing lens (optical system L) in the optical axis direction.

With this lens barrel, degradation of the optical performance of the focusing lens can be suppressed, while the same effect as with the lens barrel pertaining to the first feature can be obtained.

(F3)

The lens barrel pertaining to the third feature is the lens barrel pertaining to the first or second feature,

further including a cam mechanism (cam grooves 51d, cam pins 54c) that is subject to the drive force and guides the focusing lens (optical system L) in the optical axis direction,

wherein the cam mechanism has a cam groove (51d) and a cam follower (cam pins 54c) that is inserted into the cam groove, and

the cam groove (51d) extending in such a way that the amount of movement of the focusing lens (optical system L) in the optical axis direction resulting from a unit output driver force of the driver (focus motor 64) varies with the position of the focusing lens (optical system L) in the optical axis direction.

With this lens barrel, design latitude can be ensured for the cam mechanism or the optical system, while the same effect as with the lens barrel pertaining to the first feature can be obtained.

(F4)

The lens barrel pertaining to the fourth feature is the lens barrel pertaining to the third feature,

wherein the cam groove (51d) extends such that the surface and/or pressure angle varies with the position in the optical axis direction.

(F5)

The lens barrel pertaining to the fifth feature is the lens barrel pertaining to any of the first to fourth features,

further including a memory component (memory 40a) that stores the relationship between the drive speed (“set speed” • number of drive pulses) and the position of the focusing lens (optical system L) in the optical axis direction.

With this lens barrel, control with the controller is easier.

(F6)

The lens barrel pertaining to the sixth feature is the lens barrel pertaining to any of the first to fifth features,

wherein the driver (focus motor 64) is a stepping motor.

With this lens barrel, controlling the position of the focusing lens is easier.

(F7)

The lens barrel (interchangeable lens unit 2) pertaining to the seventh feature includes:

a focusing lens (optical system L) that changes its state of focus by moving in the optical axis direction;

a driver (focus motor 64) that outputs a drive force for driving the focusing lens in the optical axis direction;

a biasing member that biases the focusing lens (optical system L) in the optical axis direction; and

a cam mechanism (cam grooves 51d, cam pins 54c) that is subject to the drive force and guides the focusing lens (optical system L) in the optical axis direction,

wherein the cam mechanism has a cam groove (51d) and a cam follower (cam pins 54c) that is inserted into the cam groove, and

the cam groove (51d) extends in such a way that the amount of drive of the focusing lens (optical system L) in the optical axis direction resulting from a unit output driving force of the driver (focus motor 64) becomes relatively small when the focusing lens is at a position where the biasing force of the biasing member is relatively large, and becomes relatively large when the focusing lens is at a position where the biasing force of the biasing member is relatively small, within the range of movement of the focusing lens (optical system L) in the optical axis direction.

With this lens barrel, degradation of the optical performance of the focusing lens can be suppressed, while the motor that drives the focusing lens can be prevented from going out of step, and the movement speed of the focusing lens can be raised

(F8)

The lens barrel (interchangeable lens unit 2) pertaining to the eighth feature is the lens barrel pertaining to the seventh feature,

wherein the cam groove (51d) extends in such a way that the surface and/or the pressure angle becomes relatively small at a position where the biasing force of the biasing member is relatively large, and becomes relatively large at a position where the biasing force of the biasing member is relatively small.

(F9)

The lens barrel (interchangeable lens unit 2) pertaining to the ninth feature is the lens barrel pertaining to the seventh or eighth feature,

wherein the driver is a stepping motor.

With this lens barrel, controlling the position of the focusing lens is easier.

(F10)

The imaging device (digital camera 1) pertaining to the tenth feature includes:

a focusing lens (optical system L) that changes its state of focus by moving in the optical axis direction;

a driver (focus motor 64) that outputs a drive force for driving the focusing lens in the optical axis direction; and

a controller (lens microprocessor 40) that controls the driving speed (“set speed” • number of drive pulses per unit of time) of the driver,

wherein the focusing lens is subject to a load and moves in the optical axis direction, the load is dependent upon the position of the focusing lens in the optical axis direction, and

the controller controls the driver so that when the focusing lens is at a position where the load is small the driving speed (“set speed” • number of drive pulses per unit of time) is larger than the driving speed (“set speed” • number of drive pulses per unit of time) when the focusing lens is at a position where the load is large.

With this lens barrel, the motor that drives the focusing lens can be prevented from going out of step while the movement speed of the focusing lens can be raised.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including,” “having,” and their derivatives. Also, the terms “part,” “section,” “portion,” “member,” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of an imaging device and/or lens barrel equipped with a focusing lens and a driver for driving the focusing lens. Accordingly, these terms, as utilized to describe the above embodiments should be interpreted relative to an imaging device and/or lens barrel equipped with a focusing lens and a driver for driving the focusing lens.

Moreover, the term “configured” as used herein to describe a component, section, or part of a device includes hardware and/or software that is constructed and/or programmed to carry out the desired function.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1.-11. (canceled)

12. A lens barrel comprising:
a focusing lens configured to change a state of focus by moving in the direction of an optical axis, the focusing lens being subject to a load which is dependent upon the position of the focusing lens along the optical axis;
a driver coupled to the focusing lens and configured to output a driving force to move the focusing lens along the optical axis at a predetermined speed; and
a controller operatively coupled to the driver to adjust the driving speed of the driver relative to the position of the focusing lens.

13. The lens barrel according to claim 12, wherein
the controller is further configured to adjust the driving speed so that when the focusing lens is at a position where the load is small the driving speed is faster than the driving speed when the focusing lens is at a position where the load is large.

14. The lens barrel according to claim 13, further comprising
a biasing member that produces the load that biases the focusing lens in the direction of the optical axis.

15. The lens barrel according to claim 13, further comprising
a cam mechanism including a cam groove and a cam follower inserted into the cam groove, the cam mechanism being subject to the driving force so as to guide the focusing lens in the direction of the optical axis, the cam groove being formed so that the amount of movement of the focusing lens along the direction of the optical axis varies with respect to a unit output of the driver.

16. The lens barrel according to claim 15, wherein
the cam groove includes a surface that forms a pressure angle that varies along the direction of the optical axis.

17. The lens barrel according to claim 13, further comprising
a storage device coupled to the controller and configured to store information regarding the operative relationship between the driving speed of the driver and the position of the focusing lens along the direction of the optical axis.

18. The lens barrel according to claim 13, wherein the driver is a stepping motor.

19. The lens barrel according to claim 13, further comprising
a biasing member that produces the load that biases the focusing lens along the optical axis; and
a cam mechanism including a cam groove and a cam follower inserted into the cam groove, the cam mechanism being subject to the driving force so as to guide the focusing lens in the direction of the optical axis,
the cam groove being formed so that the amount of movement of the focusing lens along the optical axis varies with respect to a unit output of the driver.

20. A lens barrel comprising:
a focusing lens configured to change a state of focus by moving in the direction of an optical axis;
a driver coupled to the focusing lens and configured to output a driving force to move the focusing lens along the optical axis;
a biasing member that biases the focusing lens along the optical axis; and
a cam mechanism including a cam groove and a cam follower inserted into the cam groove, the cam mechanism being subject to the driving force so as to guide the focusing lens in the direction of the optical axis,
the cam groove being formed such that the amount of movement of the focusing lens along the optical axis resulting from a unit output driving force of the driver becomes relatively small when the focusing lens is at a position where the biasing force is relatively large and relatively large when the focusing lens is at a position where the biasing force is relatively small.

21. The lens barrel according to claim 20, wherein
the cam groove includes a surface that forms a pressure angle, the pressure angle being relatively small when the focusing lens is at a position where the biasing force is relatively large and relatively large when the focusing lens is at a position where the biasing force is relatively small.

22. The lens barrel according to claim 20, wherein the driver is a stepping motor.

23. An imaging device comprising:
a focusing lens configured to change a state of focus by moving in the direction of an optical axis, the focusing lens being subject to a load which is dependent upon the position of the focusing lens along the optical axis,
a driver coupled to the focusing lens and configured to output a driving force to move the focusing lens along the optical axis at a predetermined speed, and
a controller operatively coupled to the driver to adjust the driving speed of the driver relative to the position of the focusing lens.

24. The lens barrel according to claim 23, wherein
the controller is further configured to adjust the driving speed so that when the focusing lens is at a position where the load is small the driving speed is faster than the driving speed when the focusing lens is at a position where the load is large.

25. A variable set speed method for focusing a lens barrel with a driver coupled to a focusing lens, the method comprising:
indicating a driving speed of the driver and a target position of the focusing lens;
acquiring a present position of the focusing lens;
determining a set speed of the driver;
comparing the driving speed with the set speed; and
starting the driver.

26. The method according to claim 25, wherein
the indicating of the driving speed of the driver and the target position of the focusing lens includes determining the maximum speed at which the driver will not go out of step during driving of the focusing lens.

27. The method according to claim 26, wherein
the driving speed and the target position are chosen by a first microprocessor and transmitted to a second microprocessor.

28. The method according to claim 25, wherein
the determining of the set speed of the driver includes determining a speed that corresponds to the present position of the focusing lens moving in the direction of an optical axis.

29. A method of focusing a lens barrel comprising:
changing a state of focus of a focusing lens by moving the focusing lens along an optical axis, the focusing lens being subject to a load which is dependent upon the position of the focusing lens along the optical axis;
producing a driving force using a driver to move the focusing lens along the optical axis at a predetermined speed; and
adjusting the driving speed of the driver using a controller relative to the position of the focusing lens along the optical axis.

30. The method according to claim 29, wherein
the adjusting of the driving speed includes adjusting the driving speed so that when the focusing lens is at a position where the load is small the driving speed is faster than the driving speed when the focusing lens is at a position where the load is large.
